(19) United States
(12) Patent Application Publication
(10) Pub. No.: US 2025/0093147 A1
(43) Pub. Date: Mar. 20, 2025

(54) METHOD AND DEVICE FOR DETERMINING THE SQUARENESS OF AN ICE SKATE BLADE AND SKATE SHARPENING SYSTEM

(71) Applicant: Velasa Sports, Inc., Acton, MA (US)

(72) Inventors: Russell K. Layton, JR., Acton, MA (US); Daniel A. Beaudet, Lexington, MA (US); Ivan D. Goryachev, Nashua, NH (US)

(21) Appl. No.: 18/884,789

(22) Filed: Sep. 13, 2024

Related U.S. Application Data
(60) Provisional application No. 63/583,191, filed on Sep. 15, 2023.

(51) Int. Cl. G01B 7/305; G01B 11/26

(52) U.S. Cl. CPC G01B 7/305; G01B 11/26

(57) ABSTRACT

Method and device for determining the squareness of an ice skate blade. According to one embodiment, the device may include an electrode stator and a reading unit. The reading unit may be mechanically coupled to a carriage. The carriage, in turn, may be slidably mounted on a pair of posts for translational movement. A master roller may be disposed at one end of the carriage, and the carriage may be biased in the direction of the master roller. The electrode stator may be mechanically coupled to a plunger. The plunger, in turn, may be slidably mounted on the carriage for translational movement along the same axis as the carriage; however, the plunger may be capable of moving independently of the carriage. A slave roller may be disposed at one end of the plunger, and the plunger may be biased in the direction of the slave roller.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates generally to ice skates and relates more particularly to methods and devices used to determine the squareness of an ice skate blade.

The present disclosure relates generally to ice skates and relates more particularly to the sharpening of ice skate blades.

### Description of the Related Art

An ice skate is a type of footwear that is often worn by an individual engaged in an ice surface-related athletic activity, such as, but not limited to, ice hockey, speed skating, and figure skating. An ice skate typically comprises a boot and a blade. The boot is adapted to be worn over the wearer's foot. The blade, which is coupled to and extends downwardly from the bottom of the boot, typically extends generally parallel to the length of the boot, i.e., in a direction interconnecting the heel and the toes. The blade is typically made of steel and is typically shaped to include a first surface, a second surface, and a third surface. The first surface and the second surface are generally parallel to one another and extend vertically from the boot, with one of the first surface and the second surface facing in the direction of the outside of the foot and the other of the first surface and the second surface facing in the direction of the inside of the foot. The third surface, which typically includes some form of a depression, such as, but not limited to, a flat depression, a hollow depression, or a radius-shaped depression, interconnects the first surface and the second surface.

Where the first surface meets the third surface, a first edge is formed, and where the second surface meets the third surface, a second edge is formed. These two edges run lengthwise along the skate blade and represent the contact edges of the blade with the ice. The contact edges have both a height, which may be measured relative to the depression in the skate blade, and an evenness, which may be measured from one contact edge to the other contact edge. The magnitude of the height of a contact edge impacts a skater's maneuverability and speed. More specifically, a higher edge tends to provide a skater with greater maneuverability albeit at the expense of speed. This is because a higher edge provides more “bite” into the ice, thereby increasing the skater's ability to turn. On the other hand, a higher edge tends to result in less speed because a higher edge tends to dig deeper into the ice and, consequently, results in a greater gliding friction. By comparison, a lower edge tends to provide a skater with the ability to move at a greater speed in a straight direction but with less maneuverability. This is because a lower edge does not dig as deeply into the ice and, therefore, experiences a reduced gliding friction, thereby resulting in greater gliding speed. On the other hand, a lower edge has less “bite” into the ice, thereby decreasing maneuverability.

The evenness of the respective heights of the two contact edges affects the predictability and the consistency of maneuverability from the inside and outside contact edges. If the two contact edges are unequal in height, the lower edge will feel “duller” and less certain to the skater whereas the higher edge will feel “sharper” and more certain to the skater. Therefore, in order for the side-to-side grip into the ice to feel equal to the skater, the respective heights of the inside and outside edges need to be equal. In other words, the bottom of the skate blade needs to be square. (There may be isolated instances in which a skater, for example, a hockey goalie, may wish to have uneven inside and outside edges; however, such instances are rare, and the overwhelming majority of skaters want the bottom of a skate blade to be square.) Stated yet another way, the depression in the third surface must be “centered” relative to the two contact edges. To illustrate the above, referring now to FIGS. 1(a) and 1(b), two blades are shown relative to a skating surface S. FIG. 1(a) shows a blade 2 whose two contact edges 2-1 and 2-2 are equal in height, i.e., a square blade, whereas FIG. 1(b) shows a blade 3 whose two contact edges 3-1 and 3-2 are unequal in height, i.e., a non-square blade. As can be seen, the depression 2-3 of blade 2 appears centered relative to contact edges 2-1 and 2-2 whereas the depression 3-3 of blade 3 appears off-center relative to contact edges 3-1 and 3-2. (It should be understood that, whereas blade 3 is shown in FIG. 1(b) as being normal to skating surface S, with contact edge 3-1 being shown to be in contact with skating surface S and with contact edge 3-2 being shown not to be in contact with skating surface S, blade 3 may be angled relative to skating surface S so that both contact edge 3-1 and contact edge 3-2 are simultaneously in contact with skating surface S.)

As can be appreciated, the contact edges of a skate blade tend to wear or to become damaged over time through use. As a result, it becomes necessary, from time to time, for the skate blade to be sharpened. Such sharpening is typically effected using a machine that includes a rotating disk-shaped grinding stone. The grinding stone, which is most commonly composed of aluminum oxide, silicone carbide and/or cubic boron nitride, typically has a convexly-shaped edge profile. This convexly-shaped edge profile may be used to impart a correspondingly concavely-shaped depression in the third surface of the skate blade such that the two contact edges may be reformed. Examples of various types of skate sharpening machines are disclosed in the following documents, all of which are incorporated herein by reference: U.S. Pat. No. 8,277,284 B2, inventors Wilson et al., issued Oct. 2, 2012; U.S. Pat. No. 7,934,978 B2, inventors Wilson et al., issued May 3, 2011; U.S. Pat. No. 7,473,164 B2, inventor Sunnen, issued Jan. 6, 2009; U.S. Pat. No. 5,591,069, inventor Wurthman, issued Jan. 7, 1997; U.S. Patent Application Publication No. US 2012/0108151 A1, inventor Swist, published May 3, 2012; U.S. Patent Application Publication No. US 2012/0104705 A1, inventor Swist, published May 3, 2012; and U.S. Patent Application Publication No. US 2006/0183411 A1, inventor Moon, published Aug. 17, 2006.

Skate sharpening machines typically fall into one of two different categories, namely, manual machines and automated machines. In manual machines, the operator typically holds the ice skate blade, either with or without the aid of a mount, against the rotating grinding stone while slowly moving the ice skate relative to the grinding stone so that the entire length of the ice skate blade eventually comes into contact with the rotating grinding stone. The sharpening may be done in a single pass of the blade against the grinding stone or, as is more common, may be done in a plurality of passes (often one or more rough passes followed by one or more finishing passes). Because the grinding stone, itself, tends to lose its convex shape over time due to grinding contact with the ice skate blade, the grinding stone periodically needs to be reshaped, i.e., dressed. Such dressing is typically accomplished by having the operator manually bring a dressing tool, which is typically some form of diamond-based sharpener, into contact with the rotating grinding stone until the convex profile of the grinding stone has been restored.

As can be appreciated, if the center of the convexly-shaped edge profile of the grinding stone is not oriented properly relative to the ice skate blade or if the pressure applied to the grinding stone is not consistent, the two contact edges of the ice skate blade will be formed unevenly. Consequently, it takes a certain amount of skill to sharpen a skate blade so that the two contact edges are made to be substantially equal in height. In fact, an experienced operator of a skate sharpening machine will typically attempt to bring the heights of the two contact edges to within about 0.001 inch of each other. To confirm that the two contact edges of a re-sharpened blade are, in fact, substantially equal in height, an operator will typically use some form of manual measuring device to check the evenness of the two contact edges.

It is often difficult to determine, simply by unaided visual inspection of a skate blade, whether the contact edges of the skate blade are even and, if they are not even, to quantify the extent to which the contact edges are uneven. As a result, a number of different devices have been conceived for use in measuring the evenness of the contact edges of a skate blade. One such type of device utilizes two components, a squaring frame and a measuring bracket. The squaring frame includes a first portion and a second portion. The first portion of the squaring frame is adapted to be secured to one of the vertical surfaces of the skate blade. The second portion of the squaring frame has graduated lines or other indicia appearing thereon. The measuring bracket, which has a flat top edge, is adapted to rest on top of the peaks of the two contact edges. If the contact edges of the blade are perfectly even, then when the squaring frame and the measuring frame are attached to the skate blade, the top edge of the measuring bracket lies parallel to or otherwise aligned with the indicia on the squaring frame. On the other hand, if the contact edges of the blade are uneven, then when the squaring frame and the measuring bracket are attached to the skate blade, the top edge of the measuring bracket is oriented at an angle relative to the indicia on the measuring bracket. Consequently, a user can determine the evenness, and the magnitude of any unevenness, by noting the extent to which the top edge of the measuring bracket is offset relative to the indicia.

Examples of such devices are disclosed in the following documents, all of which are incorporated herein by reference: U.S. Pat. No. 7,918,035, inventor Jarczewski, issued Apr. 5, 2011; U.S. Pat. No. 7,748,130, inventor McKenna, issued Jul. 6, 2010; U.S. Pat. No. 7,434,324, inventor McKenna, issued Oct. 14, 2008; U.S. Pat. No. 7,191,539, inventor Zukeman, issued Mar. 20, 2007; U.S. Pat. No. 6,594,914, inventor Babcock, issued Jul. 22, 2003; and U.S. Pat. No. 5,345,688, inventor Allen, issued Sep. 13, 1994.

The present inventor has identified certain shortcomings with the foregoing type of device. For example, in certain of these devices, the squaring frame is attached to the skate blade by tightening a thumb screw. Such an arrangement requires two hands and also presents the possibility that the thumb screw may become lost from the assembly. In other of these devices, the thumb screw is replaced with a magnet. However, the use of a magnet presents the possibility that foreign material may adhere to the magnet before it is placed on the blade edge. Such foreign material may alter the positioning of the squaring frame on the skate blade and, consequently, the reading displayed on the device. Moreover, a shortcoming common to the foregoing type of device is that, in all cases, the user must interpret the angle between the squaring frame and the measuring bracket and must make a reading-a task that is not always easy to do using the indicia on the squaring frame. In particular, it is often difficult to determine exactly how much up or down relative to the horizontal the measuring bracket has been displaced. Second, the user must decide what to do with the information obtained with this reading. Ultimately, the user would want to take this measurement and make adjustments to the settings on a skate sharpener to move the skate in-line with the center of the convexly-shaped edge of the grinding wheel.

Another type of device that has been conceived for use in measuring the evenness of the contact edges of a skate blade utilizes a static 90° template that is placed against a skate blade. More specifically, with this type of device, the user places the device against the skate blade and then inspects the interface between the skate blade and the device to see if a gap is present. If there is no gap, the contact edges are equal in height whereas, if a gap is present, the contact edges are not equal in height. The following patents, all of which are incorporated herein by reference, are directed at devices of the aforementioned type: U.S. Pat. No. 7,748,130, inventor McKenna, issued Jul. 6, 2010; U.S. Pat. No. 7,434,324, inventor McKenna, issued Oct. 14, 2008; and U.S. Pat. No. 6,594,914, inventor Babcock, issued Jul. 22, 2003.

The present inventor has identified certain shortcomings with the template-type devices discussed above. First, although such template-type devices eliminate much of the mechanical complexity of the multicomponent devices described previously, such template-type devices also lack a capacity for specific measurement. In particular, such template-type devices do not enable a user to quantify the extent of unevenness; rather, they merely give the user a reference edge so that the user can determine whether or not the contact edges are square. Another shortcoming with this type of device is that the person sharpening the skate is often looking to eliminate edge unevenness to within 0.001 inch, and the ability of a person to see this small of a gap between a template and a blade edge is not easy. Furthermore, when a gap is present and perceptible by the user, the user has no way of determining the specific magnitude of the unevenness and, therefore, would not have information specific enough to make the necessary adjustment to the skate sharpening machine. Finally, in those instances in which the blade has previously been subjected to a number of sharpening procedures, the blade may have limited vertical height, which could make impractical the attachment of a device such as that shown in FIG. 1 of U.S. Pat. No. 7,748,130.

If it appears, based on the operator's reading of the manual measuring device, that the two contact edges are not substantially equal in height, the operator typically makes a mental determination of how the sharpening procedure should be modified (e.g., by having the operator hold the skate blade at a different angle, height, roll and/or pitch relative to the grinding stone and/or by having the operator make a mechanical adjustment to the skate mount and/or grinding wheel of the sharpening machine being used) and then repeats the sharpening procedure. This process of measuring the evenness of the contact edges, making some adjustment to sharpening machine, and then re-sharpening the ice skate blade may be repeated as desired. However, as can be appreciated, such a trial-and-error process can be tedious and time-consuming and may not necessarily lead to the desired outcome.

Another shortcoming with many manual machines is that large portions of the grinding stone are often left unexposed. As a result, as the grinding stone comes into contact with the ice skate blade during grinding and/or as the grinding stone comes into contact with the dresser during dressing, dust and/or sparks can be thrown from the grinding stone in the direction of the operator or the operator environment, thereby posing a safety risk to the operator and/or others nearby.

Automated machines, in which the operator mounts the ice skate in a holder and, thereafter, the machine moves either the ice skate or the grinding stone in such a way that the grinding wheel re-sharpens the ice skate blade, address some, but not all, of the shortcomings associated with manual machines.

Finally, both manual machines and automated machines tend to be rather expensive, with automated machines typically being even more expensive than manual machines. In fact, the expense of both manual machines and automated machines tends to be prohibitively expensive for most skaters, who can instead simply have their skates sharpened at a rink or specialty shop at a fraction of the cost of purchasing a machine.

### SUMMARY

It is an object of the present disclosure to provide a novel skate sharpening system.

It is another object of the present disclosure to provide a skate sharpening system as described above that overcome at least some of the shortcomings associated with existing skate sharpening systems and methods.

According to one aspect of the disclosure, there is provided a skate sharpening system for sharpening an ice skate blade of an ice skate, the skate sharpening system comprising (a) a skate sharpener, the skate sharpener being capable of being operated at a plurality of alternate settings; and (b) a skate checker, the skate checker being adapted to check the squareness of the ice skate blade and, based on the squareness of the ice skate blade, being adapted to provide a recommendation on a suitable setting for the skate sharpener.

It is another object of the present disclosure to provide a novel skate sharpener.

According to one aspect of the disclosure, there is provided a skate sharpener for sharpening an ice skate blade of an ice skate, the skate sharpener comprising (a) a housing, the housing having an opening; (b) a grinding stone adapted for shaping an ice skate blade, the grinding stone extending through the opening in the housing; (c) a motor operatively coupled to the grinding stone to cause the grinding stone to rotate; and (d) a vacuum disposed within the housing for suctioning debris created by the shaping of the ice skate blade by the grinding stone.

According to another aspect of the disclosure, there is provided a skate sharpener for sharpening an ice skate blade of an ice skate, the skate sharpener comprising (a) a grinding stone adapted for shaping an ice skate blade; (b) a motor operatively coupled to the grinding stone to cause the grinding stone to rotate; and (c) a dresser adapted to dress the grinding stone, wherein control of the dresser is automated.

According to another aspect of the disclosure, there is provided a skate sharpener for sharpening an ice skate blade of an ice skate, the skate sharpener comprising (a) a grinding stone adapted for shaping an ice skate blade; (b) a motor operatively coupled to the grinding stone to cause the grinding stone to rotate; (c) a skate mount for holding an ice skate; and (d) a spring-loaded pivot mechanism for maintaining constant force of the grinding stone against the ice skate in the skate mount.

According to another aspect of the disclosure, there is provided a skate sharpener for sharpening an ice skate blade of an ice skate, the skate sharpener comprising (a) a grinding stone adapted for shaping an ice skate blade; (b) a motor operatively coupled to the grinding stone to cause the grinding stone to rotate; (c) a skate mount for holding an ice skate; and (d) a counterweight coupled to the grinding stone for maintaining constant force of the grinding stone against the ice skate in the skate mount.

According to another aspect of the disclosure, there is provided a skate sharpener for sharpening an ice skate blade of an ice skate, the skate sharpener comprising (a) a grinding stone adapted for shaping an ice skate blade; (b) a motor operatively coupled to the grinding stone to cause the grinding stone to rotate; (c) a skate mount adapted to hold an ice skate; and (d) a mechanism for moving the skate mount relative to the grinding stone, the mechanism comprising a rail, the skate mount slidably mounted on the rail, and motorized means for driving the skate mount along the rail.

According to one aspect of the disclosure, there is provided a device for determining the squareness of an ice skate blade, the ice skate blade having a first contact edge and a second contact edge, the device comprising (a) a support; (b) a first contact member, the first contact member being adapted to be displaced relative to the support when the first contact member is brought into contact with the first contact edge of the ice skate blade, the first contact member being biased towards making contact with the first contact edge of the ice skate blade; (c) a second contact member, the second contact member being capable of being displaced relative to the first contact member when the second contact member is brought into contact with the second contact edge of the ice skate blade, the second contact member being biased towards making contact with the second contact edge of the ice skate blade; and (d) automated means for determining the displacement of the second contact member relative to the first contact member. Such automated means may comprise any displacement determining means that does not require human intervention. For illustrative purposes only, such automated means may comprise, for example, a capacitive measurement circuit, an inductive measurement circuit or any other measurement sensor arrangement, whether electrical, mechanical, optical or otherwise.

According to another aspect of the disclosure, there is provided a device for determining the squareness of an ice skate blade, the ice skate blade having a first surface, a second surface, and a connecting surface, the first surface and the connecting surface meeting at a first contact edge, the second surface and the connecting surface meeting at a second contact edge, the device comprising (a) a squaring frame, the squaring frame comprising a frame body and an elongated member, the frame body being adapted to be mounted along one of the first surface and the second surface of the ice skate blade, with the elongated member extending perpendicularly to the frame body; (b) a measuring bracket, the measuring bracket being adapted to be seated across the first and second contact edges of the ice skate blade; and (c) automated means for determining the angular displacement of the measuring bracket relative to the elongated member of the squaring frame. Such automated means may comprise any angular displacement determining means that does not require human intervention. For illustrative purposes only, such automated means may comprise, for example, a capacitive measurement circuit, an inductive measurement circuit or any other measurement sensor arrangement, whether electrical, mechanical, optical or otherwise.

According to another aspect of the disclosure, there is provided a device for determining the squareness of an ice skate blade, the ice skate blade having a first contact edge and a second contact edge, the device comprising (a) a first contact member, the first contact member being adapted to contact the first contact edge of the ice skate blade; (b) a second contact member, the second contact member being capable of being displaced relative to the first contact member when the second contact member is brought into contact with the second contact edge of the ice skate blade, the second contact member being biased towards making contact with the second contact edge of the ice skate blade; and (c) automated means for determining the displacement of the second contact member relative to the first contact member. Such automated means may comprise any displacement determining means that does not require human intervention. For illustrative purposes only, such automated means may comprise, for example, a capacitive measurement circuit, an inductive measurement circuit or any other measurement sensor arrangement, whether electrical, mechanical, optical or otherwise.

According to another aspect of the disclosure, there is provided a device for determining the squareness of an ice skate blade, the ice skate blade having a first surface, a second surface, and a connecting surface, the first surface and the connecting surface meeting at a first contact edge, the second surface and the connecting surface meeting at a second contact edge, the device comprising: (a) a first light source, the first light source generating a first line of light; (b) a second light source, the second light source generating a second line of light; (c) a first light detector, the first light detector comprising a first array of photodiodes; (d) a second light detector, the second light detector comprising a second array of photodiodes; (e) wherein the first light source and the first light detector are positioned on opposite sides of the ice skate blade, wherein the first light detector is positioned such that a portion of the photodiodes of the first array is illuminable with the first line of light and a portion of the photodiodes of the first array is not illuminable with the first line of light due to the presence of the first contact edge; (f) wherein the second light source and the second light detector are positioned on opposite sides of the ice skate blade, wherein the first light source and the second light source are positioned on opposite sides of the ice skate blade, and wherein the second light detector is positioned such that a portion of the photodiodes of the second array is illuminable with the second line of light and a portion of the photodiodes of the second array is not illuminable with the second line of light due to the presence of the second contact edge; and (g) automated means for determining the squareness of the ice skate blade based on the relative portions of illuminated photodiodes in the first and second light detectors. Such automated means may comprise any determining means that does not require human intervention.

According to another aspect of the disclosure, there is provided a device for determining the squareness of an ice skate blade, the ice skate blade having a first surface, a second surface, and a connecting surface, the first surface and the connecting surface meeting at a first contact edge, the second surface and the connecting surface meeting at a second contact edge, the device comprising (a) a support; (b) a first contact member, the first contact member being adapted to be displaced relative to the support when the first contact member is brought into contact with the first contact edge of the ice skate blade, the first contact member being biased towards making contact with the first contact edge of the ice skate blade; (c) a first light source, the first light source generating a first line of light; (d) a first light detector, the first light detector comprising a first array of photodiodes; (e) wherein the first light source and the first light detector are positioned on opposite sides of the ice skate blade, wherein the first light detector is positioned such that a portion of the photodiodes of the first array is illuminable with the first line of light and a portion of the photodiodes of the first array is not illuminable with the first line of light due to the presence of the second contact edge; and (f) automated means for determining the squareness of the ice skate blade by measuring the height of the second contact edge relative to the first contact edge using the relative portions of illuminated and nonilluminated photodiodes in the first light detector. Such automated means may comprise any determining means that does not require human intervention.

According to another aspect of the disclosure, there is provided a method for determining the squareness of an ice skate blade, the ice skate blade having a first contact edge and a second contact edge, the method comprising: (a) providing a first contact member, the first contact member being adapted to contact the first contact edge of the ice skate blade; (b) providing a second contact member, the second contact member being capable of being displaced relative to the first contact member when the second contact member is brought into contact with the second contact edge of the ice skate blade, the second contact member being biased towards making contact with the second contact edge of the ice skate blade; (c) bringing the first contact edge of the ice skate blade into contact with the first contact member; (d) bringing the second contact edge of the ice skate blade into contact with the second contact member; (e) using automated means to determine the displacement of the second contact member relative to the first contact member. Such automated means may comprise any displacement determining means that does not require human intervention. For illustrative purposes only, such automated means may comprise, for example, a capacitive measurement circuit, an inductive measurement circuit or any other measurement sensor arrangement, whether electrical, mechanical, optical or otherwise.

According to another aspect of the disclosure, there is provided a method of sharpening an ice skate blade, said method comprising the steps of (a) using a skate sharpening machine to sharpen the ice skate blade; (b) then, determining the squareness of the ice skate blade with a squareness determining device, the squareness determining device comprising automated means for recommending any needed setting adjustments to be made to the skate sharpening machine; (c) then, if needed, adjusting one or more settings to the skate sharpening machine pursuant to the recommendations of the squareness determining device and then repeating steps (a) and (b) one or more times until the ice skate blade is sharpened to a desired squareness.

For purposes of the present specification and claims, various relational terms like “top,” “bottom,” “proximal,” “distal,” “upper,” “lower,” “front,” and “rear” are used to describe the present disclosure when said disclosure is positioned in or viewed from a given orientation. It is to be understood that, by altering the orientation of the disclosure, certain relational terms may need to be adjusted accordingly.

Additional objects, as well as aspects, features and advantages, of the present disclosure will be set forth in part in the description which follows, and in part will be obvious from the description or may be learned by practice of the disclosure. In the description, reference is made to the accompanying drawings which form a part thereof and in which is shown by way of illustration various embodiments for practicing the disclosure. The embodiments will be described in sufficient detail to enable those skilled in the art to practice the disclosure, and it is to be understood that other embodiments may be utilized and that structural changes may be made without departing from the scope of the disclosure. The following detailed description is, therefore, not to be taken in a limiting sense, and the scope of the present disclosure is best defined by the appended claims.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings. The accompanying drawings, which are incorporated in, and constitute a part of, this specification, illustrate embodiments of the disclosure. Embodiment of the present disclosure are illustrated by way of example, and not by way of limitation, in the figures of the accompanying drawings and in which like references indicate similar elements. According to common practice, the various features of the drawings discussed below are not necessarily drawn to scale. The drawings are provided to illustrate example embodiments described herein and are not intended to limit the scope of the disclosure.

FIGS. 1(a) and 1(b) are schematic section views of a square blade and a non-square blade, respectively, seated on a skating surface;

FIG. 2 is a schematic diagram of one embodiment a skate sharpening system according to the present disclosure;

FIGS. 3(a) through 3(g) are top left front perspective, top left rear perspective, top right front perspective, bottom right front perspective, top, rear, and left side views, respectively, of a first embodiment of the skate sharpener of FIG. 2, certain components of the skate sharpener not being shown in all views for clarity;

FIG. 3(h) is a top right front perspective view of the housing shown in FIG. 3(a), with a portion of the housing removed to reveal certain components disposed therewithin;

FIGS. 4(a) and 4(b) are top perspective and bottom perspective views, respectively, of the first mounting plate shown in FIG. 3(a);

FIGS. 5(a) and 5(b) are front and rear perspective views, respectively, of the top rail holder shown in FIG. 3(a);

FIGS. 6(a) and 6(b) are front and rear perspective views, respectively, of the bottom rail holder shown in FIG. 3(a);

FIG. 7(a) is a perspective view of one of the two rails shown in FIG. 3(a);

FIG. 7(b) is a perspective view of the other of the two rails shown in FIG. 3(a);

FIGS. 8(a) and 8(b) are front and rear perspective views, respectively, of the second mounting plate shown in FIG. 3(a);

FIG. 9 is a perspective view of the first mounting collar shown in FIG. 3(b);

FIG. 10 is a perspective view of the first shaft shown in FIG. 3(f);

FIGS. 11(a) and 11(b) are front and rear perspective views, respectively, of the second mounting collar shown in FIG. 3(c);

FIG. 12 is a perspective view of the second shaft shown in FIG. 3(f);

FIG. 13 is a perspective view of the lever shown in FIG. 3(f);

FIG. 14 is a schematic diagram illustrating how the grinding stone of the skate sharpener of FIG. 3(a) applies constant force regardless of the angle of the skate sharpener housing;

FIG. 15 is a schematic diagram illustrating one way in which the force at the grinding/skate interface may be adjusted for coarse or fine sharpening passes;

FIG. 16 is a schematic diagram illustrating another way in which the force at the grinding/skate interface may be adjusted for coarse or fine sharpening passes;

FIG. 17 is a perspective view of a first alternate embodiment of a skate sharpener to the skate sharpener of FIGS. 3(a) through 3(g);

FIG. 18 is a perspective view of the housing shown in FIG. 17, with a portion of the housing removed to reveal the contents of housing;

FIG. 19 is a perspective view of a second alternate embodiment of a skate sharpener to the skate sharpener of FIGS. 3(a) through 3(g);

FIG. 20 is a perspective view of a first embodiment of a device for determining the squareness of an ice skate blade;

FIG. 21 is an exploded perspective view of the device shown in FIG. 20;

FIGS. 22(a) through 22(c) are front perspective, rear perspective, and top perspective views, respectively, of the device shown in FIG. 20, with certain components of the device not being shown to reveal other components of the device;

FIGS. 23(a) and 23(b) are enlarged top perspective and enlarged bottom perspective views, respectively, of the first support member shown in FIG. 21;

FIGS. 24(a) and 24(b) are enlarged top perspective and enlarged bottom perspective views, respectively, of the second support member shown in FIG. 21;

FIG. 25(a) is an enlarged perspective view of one of the two posts shown in FIG. 21, and FIG. 25(b) is an enlarged perspective view of the other of the two posts shown in FIG. 21;

FIGS. 26(a) and 26(b) are enlarged front perspective and enlarged section views, respectively, of the carriage shown in FIG. 21;

FIG. 27 is an enlarged perspective view of the plunger shown in FIG. 21;

FIGS. 28(a) and 28(b) are enlarged front and rear perspective views, respectively, of the front housing portion;

FIGS. 29(a) and 29(b) are enlarged front and rear perspective views, respectively, of the rear housing portion;

FIGS. 30(a) and 30(b) are enlarged top and bottom perspective views, respectively, of the left blade guide;

FIGS. 31(a) and 31(b) are enlarged top and bottom perspective views, respectively, of the right blade guide;

FIGS. 32(a) through 32(c) are schematic diagrams, illustrating how the device of FIG. 20 may be used to measure the evenness of a skate blade;

FIGS. 33(a) and 33(b) are graphic depictions of the evenness of a skate blade using the device of FIG. 20;

FIG. 34 is a front perspective view of a second embodiment of a device for determining the squareness of an ice skate blade, the device being shown mounted on an ice skate blade;

FIGS. 35(a) and 35(b) are rear perspective views of the device shown in FIG. 34, with certain components of the squaring frame assembly not being shown, the device being shown mounted on an ice skate blade;

FIG. 36 is a front perspective view of the squaring frame assembly shown in FIG. 34, the squaring frame assembly being shown mounted on an ice skate blade;

FIG. 37 is a front perspective view, broken away in part, of the squaring frame assembly shown in FIG. 34, the squaring frame assembly being shown mounted on an ice skate blade;

FIG. 38 is a front perspective view of a third embodiment of a device for determining the squareness of an ice skate blade, the device being shown mounted on an ice skate blade;

FIG. 39 is a front perspective view of a fourth embodiment of a device for determining the squareness of an ice skate blade, the device being shown mounted on an ice skate blade;

FIG. 40 is a front perspective view of the device shown in FIG. 39, with the light detecting mechanism not being shown, the device being shown mounted on an ice skate blade;

FIG. 41 is a front perspective view of the squaring frame assembly shown in FIG. 39, with the light detecting mechanism not being shown, the device shown mounted on an ice skate blade;

FIG. 42 is a rear view of the light detecting mechanism of the device of FIG. 39;

FIG. 43 is a front perspective view of a fifth embodiment of a device for determining the squareness of an ice skate blade, with the light detecting mechanism not being shown, the device being shown mounted on an ice skate blade;

FIG. 44 is a schematic top view of a sixth embodiment of a device for determining the squareness of an ice skate blade, the device being shown in use with an ice skate blade;

FIG. 45 is a schematic end view of the device of FIG. 44, with one of the two light emitter-light detector pairs not being shown, the device being shown in use with an ice skate blade;

FIG. 46 is a schematic perspective view of the device of FIG. 44, the device being shown in use with an ice skate blade;

FIG. 47 is a schematic end view of a seventh embodiment of a device for determining the squareness of an ice skate blade, one of the emitter-detector pairs not being shown, the device being shown in use with an ice skate blade; and

FIG. 48 is a perspective view of an eighth embodiment of a device for determining the squareness of an ice skate blade, the device being shown with an ice skate blade.

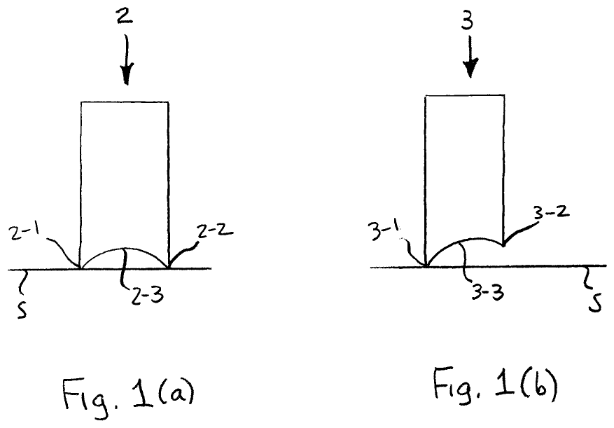

### DETAILED DESCRIPTION OF SOME EMBODIMENTS

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” or “another embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

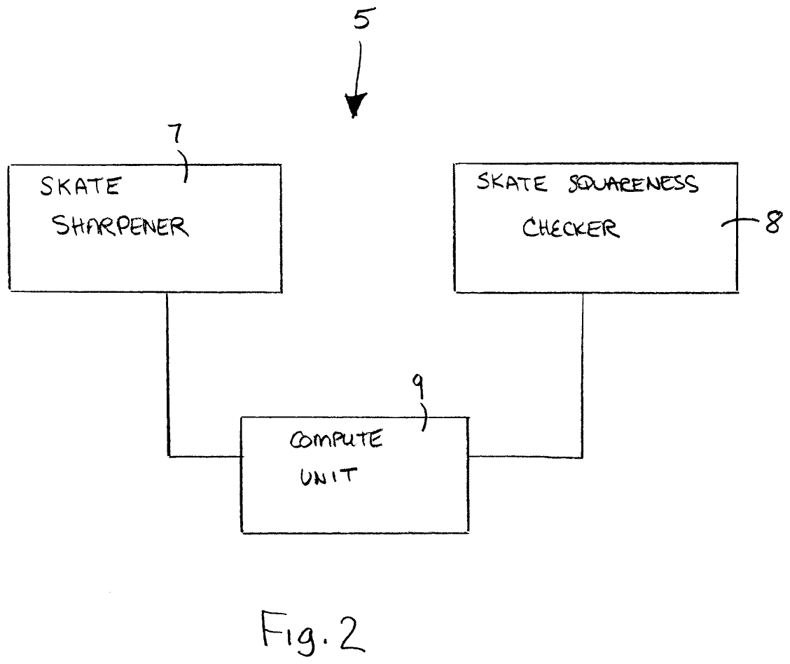

Referring now to FIG. 2, there is schematically shown a first embodiment of a skate sharpening system constructed according to the present disclosure, the skate sharpening system being represented generally by reference numeral 5.

Skate sharpening system 5 may comprise a skate sharpener 7, a skate squareness checker 8, and a compute device 9. Although skate sharpener 7, skate squareness checker 8, and compute device 9 are represented in FIG. 2 as three discrete components, it is to be understood that portions or the entireties of one or more components may be incorporated into one or more of the other components.

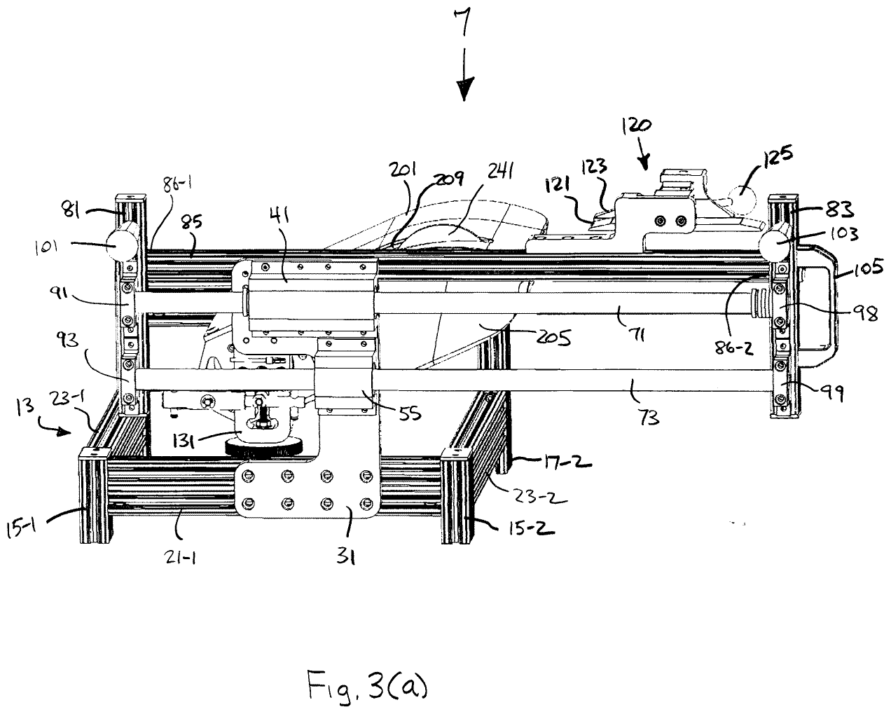

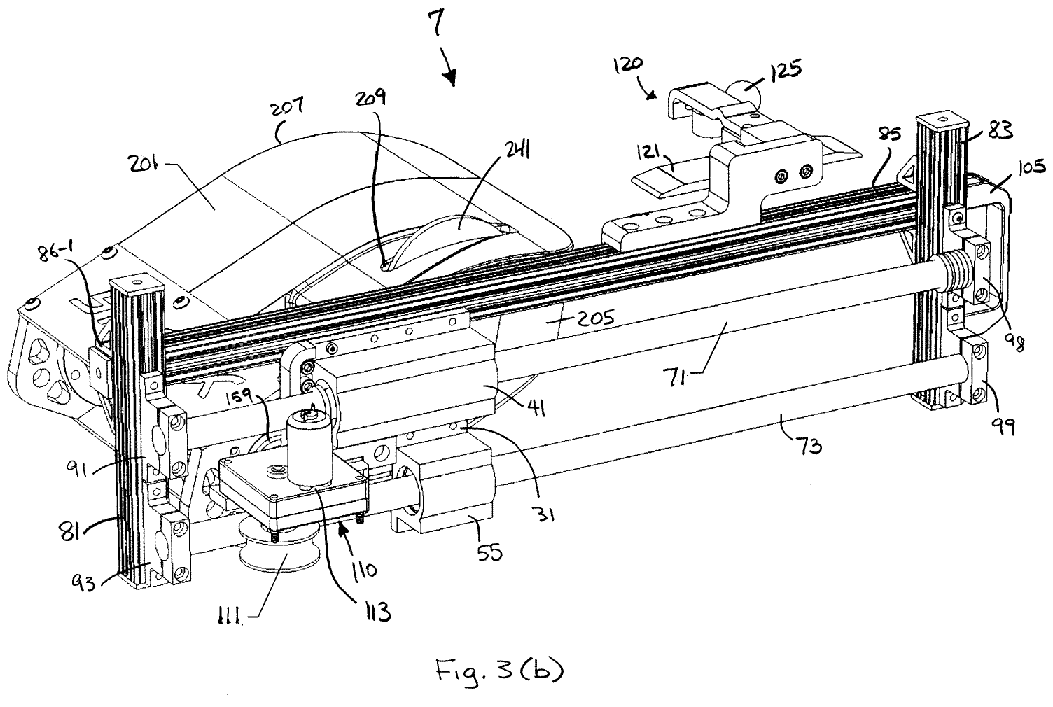

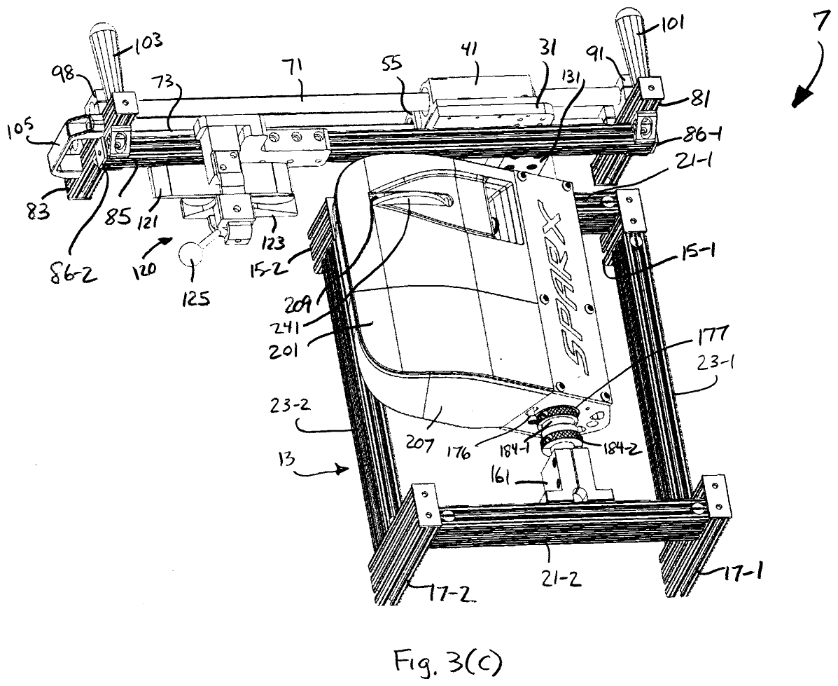

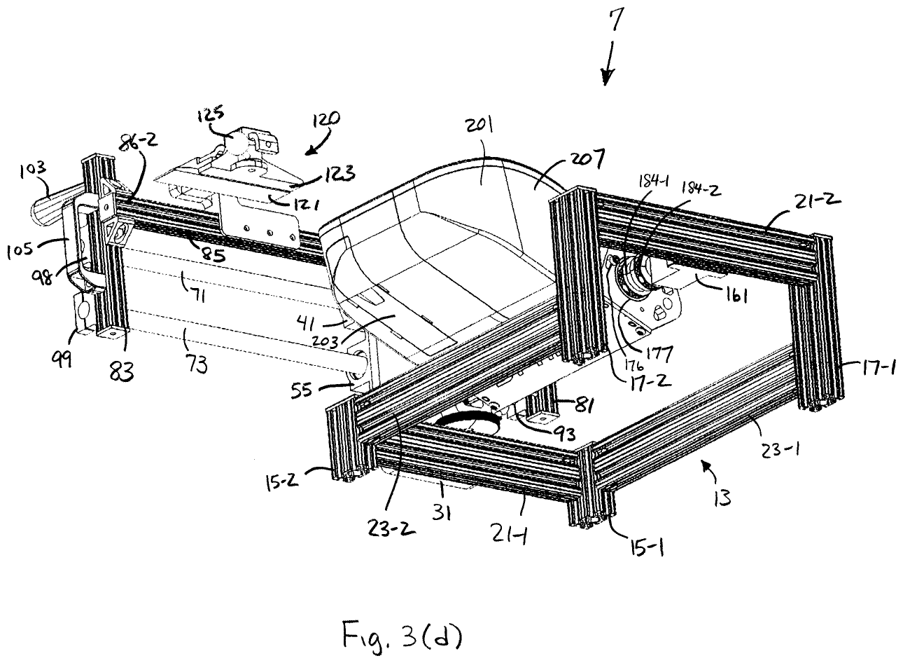

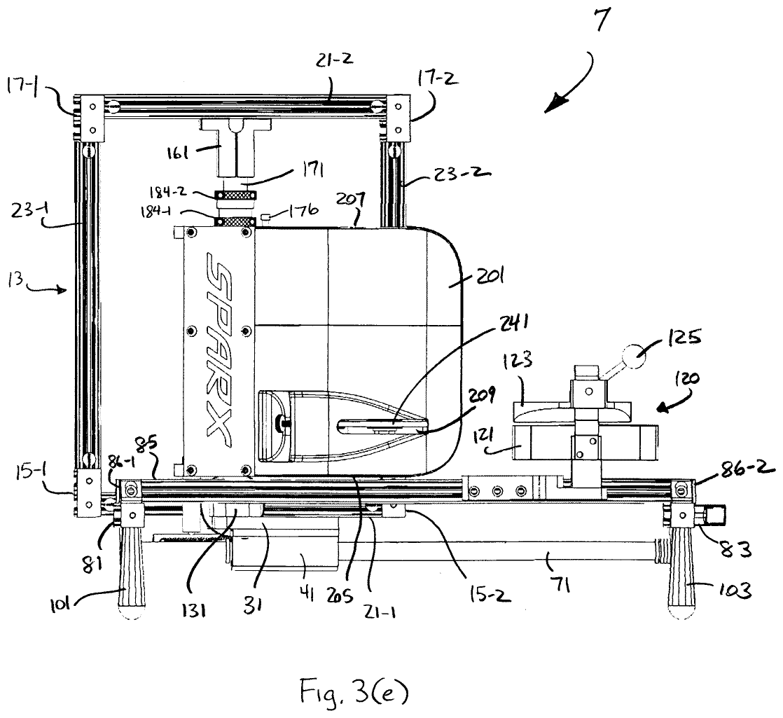

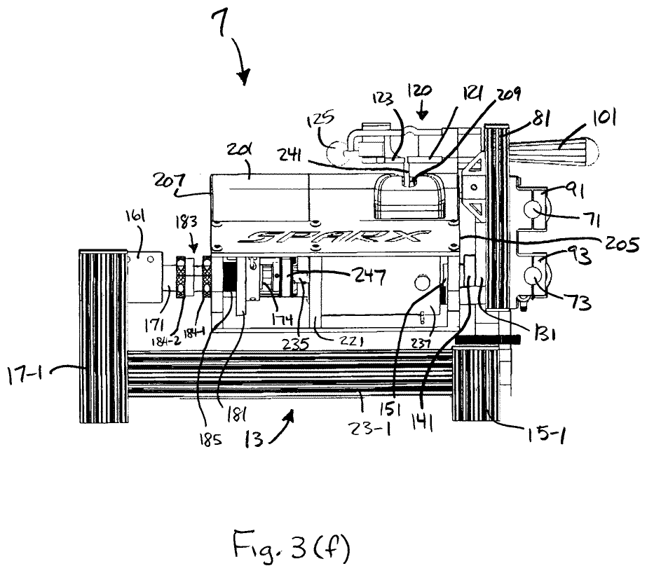

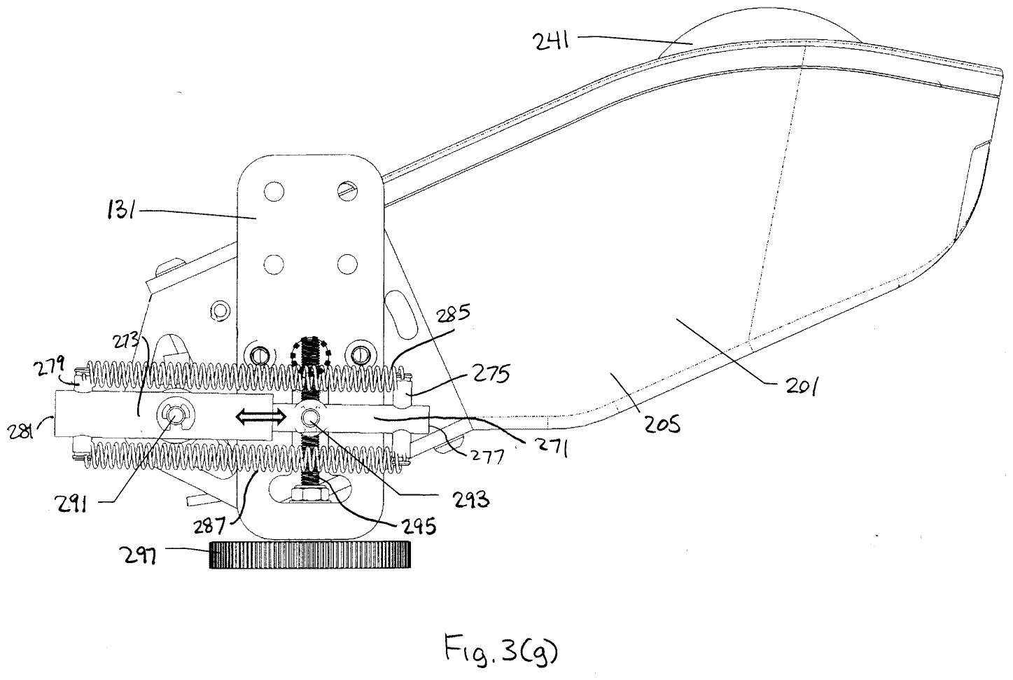

Referring now to FIGS. 3(a) through 3(g), there are shown various views of a first embodiment of skate sharpener 7. (Certain components of skate sharpener 7 are omitted from certain of FIGS. 3(a) through 3(g) for clarity and explication.) Sharpener 7 may comprise a base 13. Base 13, in turn, may comprise a pair of short posts 15-1 and 15-2 and a pair of tall posts 17-1 and 17-2. Each of short posts 15-1 and 15-2 and tall posts 17-1 and 17-2 may be a unitary structure and may be made of a hard material, such as a hard polymer, metal, or other similarly suitable material. Short posts 15-1 and 15-2 and tall posts 17-1 and 17-2 may be adapted to sit on a table top or similar surface and may be arranged to define the corners of a generally rectangular structure, with short posts 15-1 and 15-2 representing two adjacent corners and with tall posts 17-1 and 17-2 representing two other adjacent corners.

Base 13 may further comprise a pair of longitudinal beams 21-1 and 21-2 and a pair of transverse beams 23-1 and 23-2. Each of longitudinal beams 21-1 and 21-2 and transverse beams 23-1 and 23-2 may be a unitary structure and may be made of a hard material, such as a hard polymer, metal, or other similarly suitable material. Longitudinal beam 21-1 may be secured, by screws or other suitable fastening means, at one end to short post 15-1 and at the opposite end to short post 15-2. Longitudinal beam 21-2 may be secured, by screws or other suitable fastening means, at one end to tall post 15-1 and at the opposite end to tall post 15-2. For reasons to become apparent, longitudinal beam 21-2 may be secured to tall posts 15-1 and 15-2 at a height that is greater than the height at which longitudinal beam 21-1 may be positioned. Transverse beam 23-1 may be secured, by screws or other suitable fastening means, at one end to short post 15-1 and at the opposite end to tall post 17-1, and transverse beam 23-2 may be secured, by screws or other suitable fastening means, at one end to short post 15-2 and at the opposite end to tall post 17-2.

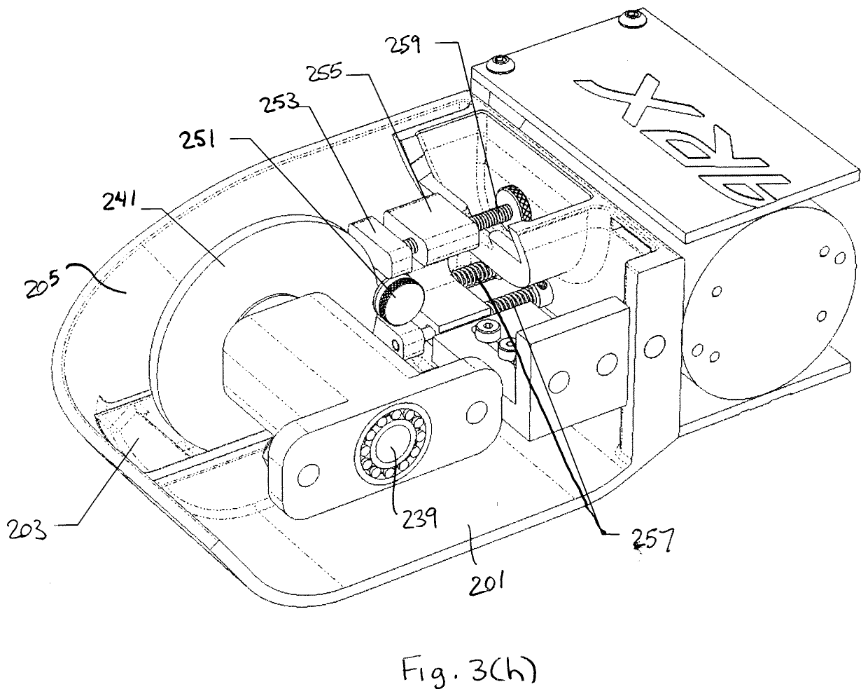

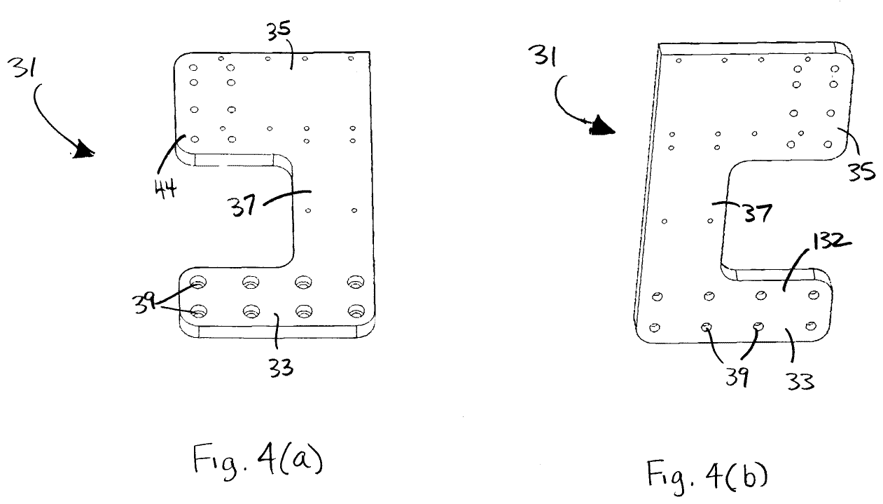

Sharpener 7 may further comprise a first mounting plate 31. First mounting plate 31, which is also shown separately in FIGS. 4(a) and 4(b), may be a unitary structure and may be made of a hard material, such as a hard polymer, metal, or other similarly suitable material. First mounting plate 31 may be generally C-shaped and may include a lower arm 33, an upper arm 35, and a connecting member 37. Lower arm 33 may be shaped to include a plurality of transverse openings 39, which may be used to receive screws for securing lower arm 33 to longitudinal beam 21-1.

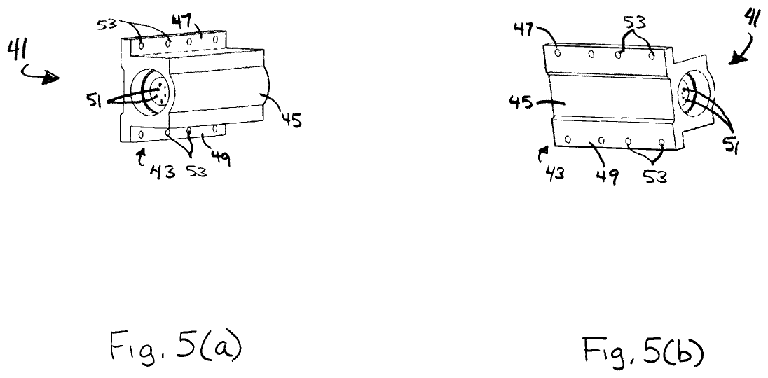

Sharpener 7 may further comprise a top rail guide 41. Top rail guide 41, which is also shown separately in FIGS. 5(a) and 5(b), may comprise a holder 43. Holder 43 may be a unitary structure and may be made of a hard material, such as a hard polymer, metal, or other similarly suitable material. Holder 43 may be shaped to include a tubular portion 45, an upper flange 47, and a lower flange 49. Linear bearings 51 may be mounted within tubular portion 45 for reasons to become apparent below. Upper flange 47 and lower flange 49 may be provided with transverse openings 53, which may be used to receive screws for securing holder 43 to a front surface 44 of first mounting plate 31.

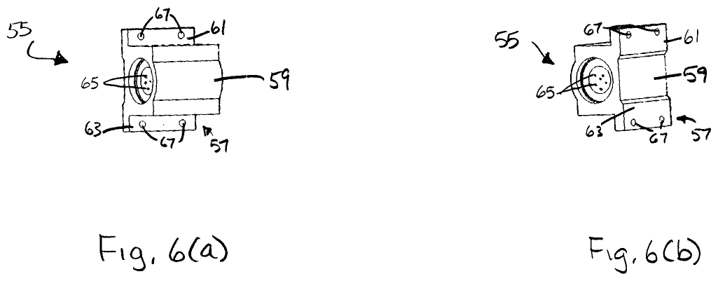

Sharpener 7 may further comprise a bottom rail guide 55. Bottom rail guide 55, which is also shown separately in FIGS. 6(a) and 6(b), may comprise a holder 57. Holder 57 may be a unitary structure and may be made of a hard material, such as a hard polymer, metal, or other similarly suitable material. Holder 57 may be shaped to include a tubular portion 59, an upper flange 61, and a lower flange 63. Linear bearings 65 may be mounted within tubular portion 59 for reasons to become apparent below. Upper flange 61 and lower flange 63 may be provided with transverse openings 67, which may be used to receive screws for securing holder 57 to front surface 44 of first mounting plate 31.

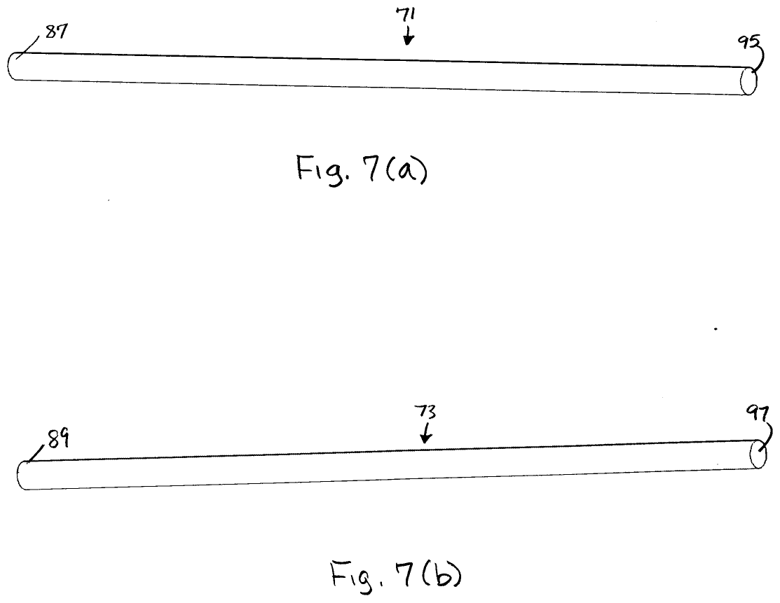

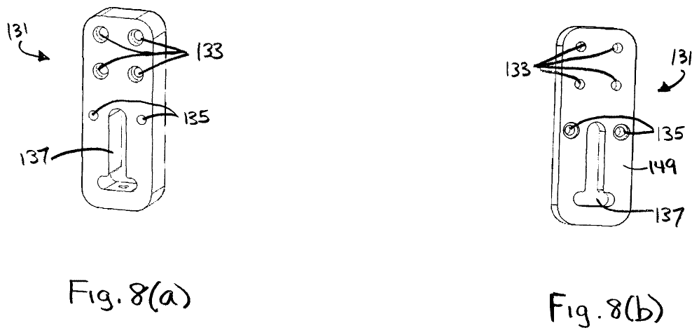

Sharpener 7 may further comprise a pair of rails 71 and 73. Rails 71 and 73, which are also shown separately in FIGS. 7(a) and 7(b), respectively, may be unitary structures of generally cylindrical shape and may be made of a hard material, such as a hard polymer, metal or other similarly suitable material. Rail 71 may be slidably mounted in holder 43 of top rail guide 41, and rail 73 may be slidably mounted in holder 57 of bottom rail guide 55. Rails 71 and 73 may be oriented substantially parallel to one another.

Sharpener 7 may further comprise a rail coupling assembly. In the present embodiment, the rail coupling assembly may comprise a first beam 81, a second beam 83, and a third beam 85. Each of first beam 81, second beam 83, and third beam 85 may be a unitary structure and may be made of a hard material, such as a hard polymer, metal, or other similarly suitable material. First beam 81 and second beam 83 may be oriented generally parallel to one another and may be oriented generally perpendicular to longitudinal beams 21-1 and 21-2 and transverse beams 23-1 and 23-2. Third beam 85 may be oriented generally perpendicular to first beam 81 and second beam 83, with a first end 86-1 of third beam 85 being secured to first beam 81 by screws or other suitable fastening means and with a second end 86-2 of third beam 85 being secured to second beam 83 by screws or other suitable fastening means. Each of a first end 87 of rail 71 and a first end 89 of rail 73 may be mechanically coupled to first beam 81 by mounting brackets 91 and 93, respectively, and each of a second end 95 of rail 71 and a second end 97 of rail 73 may be mechanically coupled to second beam 83 by mounting brackets 98 and 99, respectively. A handle 101 may be fixedly mounted on first beam 81, and handles 103 and 105 may be fixedly mounted on second beam 83.

Sharpener 7 may further comprise a mechanism 110 (see, for example, FIG. 3(b)) for slidably moving rails 71 and 73 relative to top rail guide 41 and bottom rail guide 55, respectively. In the present embodiment, mechanism 110 may comprise a friction wheel 111 and a motor 113, friction wheel 111 being adapted for rotatable movement and being operatively coupled to motor 113. Friction wheel 111 may be appropriately positioned relative to rail 73 so that rotation of friction wheel 111 causes rail 73, as well as the other components mechanically coupled to rail 73, such as rail 71, to slide relative to rail guides 41 and 55, with the direction in which rails 71 and 73 slide depending on the direction of rotation of friction wheel 111. The operation of motor 113 may be controlled by compute device 9.

Sharpener 7 may further comprise an ice skate mounting assembly 120. In the present embodiment, ice skate mounting assembly 120 may be in the form of vise-type clamp and may comprise a first bar 121 and a second bar 123. First bar 121 may be fixedly coupled to third beam 85, and second bar 123, which may be generally parallel to first bar 121, may be movable towards or away from first bar 121 by manual operation of a handle 125. First bar 121 and second bar 123 may be used to secure an ice skate blade therebetween, with first bar 121 contacting one of the vertical surfaces of the blade and with second bar 123 contacting the other of the vertical surfaces of the blade.

In view of the above, by securing an ice skate to assembly 120 and by actuating mechanism 110, the ice skate can be made to move in concert with rails 71 and 73. Alternatively, as will be discussed further below, rails 71 and 73 may be arranged so as to remain stationary whereas the ice skate can be made to move relative to rails 71 and 73, or, in yet another arrangement, both rails 71 and 73 and the ice skate may be arranged so as to remain stationary whereas the grinding stone can be made to move relative to the ice skate.

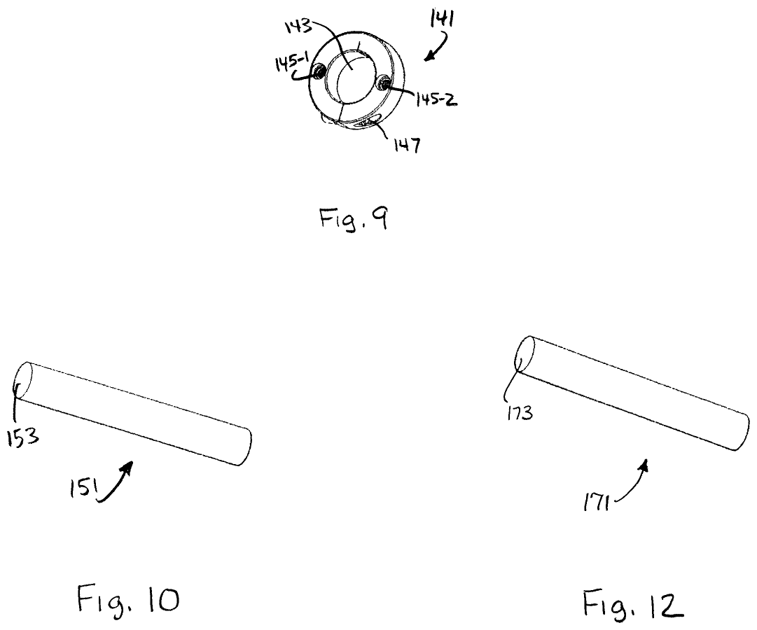

Sharpener 7 may further comprise a second mounting plate 131. Second mounting plate 131, which is also shown separately in FIGS. 8(a) and 8(b), may be a unitary structure and may be made of a hard material, such as a hard polymer, metal, or other similarly suitable material. Second mounting plate 131, which may be generally rectangular in shape, may be shaped to include a first plurality of transverse openings 133, a second plurality of openings 135, and an inverted T-shaped slot 137. Openings 133 may be used to receive screws for securing second mounting plate 131 to a rear surface 132 of first mounting plate 31.

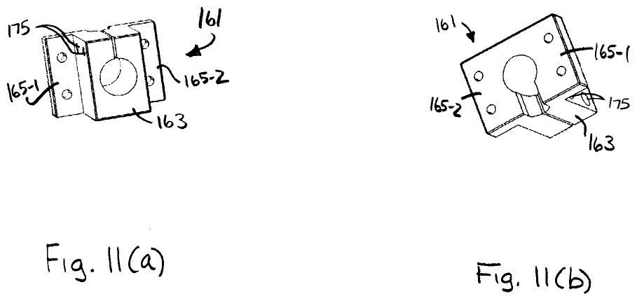

Sharpener 7 may further comprise a first mounting collar 141 (see, for example, FIG. 3(f)). First mounting collar 141, which is also shown separately in FIG. 9, may be a unitary structure and may be made of a hard material, such as a hard polymer, metal, or other similarly suitable material. First mounting collar 141, which may be generally annular in shape, may be shaped to include a central bore 143, a pair of side bores 145-1 and 145-2, and a peripheral bore 147. Side bores 145-1 and 145-2 may be used to receive screws for securing first mounting collar 141 to a rear surface 149 of second mounting plate 131 using openings 135 of second mounting plate 131.

Sharpener 7 may further comprise a first shaft 151 (see, for example, FIG. 3(f)). First shaft 151, which is also shown separately in FIG. 10, may be a unitary structure and may be made of a hard material, such as a hard polymer, metal, or other similarly suitable material. A first end 153 of first shaft 151 may be disposed within central bore 143 of first mounting collar 141 and may be fixed in place by a tightening screw inserted into peripheral bore 147. An intermediate portion of first shaft 151 may be inserted through the central bore of an annular bearing 159 (see, for example, FIG. 3(b)). As will be discussed further below, annular bearing 159 may be fixedly mounted within a housing for the grinding stone. In this manner, said housing may be rotatably mounted about first shaft 151.

Sharpener 7 may further comprise a second mounting collar 161. Second mounting collar 161, which is also shown separately in FIGS. 11(a) and 11(b), may be a unitary structure and may be made of a hard material, such as a hard polymer, metal, or other similarly suitable material. Second mounting collar 161 may be shaped to include a tubular portion 163 and a pair of side flanges 165-1 and 165-2. Side flanges 165-1 and 165-2 may be used to receive screws for securing second mounting collar 161 to longitudinal beam 21-2.

Sharpener 7 may further comprise a second shaft 171 (see, for example, FIGS. 3(e) and 3(f)). Second shaft 171, which is also shown separately in FIG. 12, may be a unitary structure and may be made of a hard material, such as a hard polymer, metal, or other similarly suitable material. A first end 173 of second shaft 171 may be disposed within tubular portion 163 of second mounting collar 141 and may be fixed in place by tightening screws inserted into openings 175 in tubular portion 163 of second mounting collar 141. An intermediate portion of second shaft 171 may be inserted through the central bore of an annular bearing 177 (see, for example, FIGS. 3(c) and 3(d)) fixedly mounted within the housing for the grinding stone. In this manner, said housing may be rotatably mounted about second shaft 171, as well as first shaft 151. Such rotation of the housing may be delimited by a stop 176.

Sharpener 7 may further comprise a mechanism for adjusting the positioning of annular bearing 177 along the longitudinal axis of second shaft 171. As will become apparent below, by adjusting the positioning of annular bearing 177 relative to second shaft 171, one may adjust the spacing of the grinding stone relative to longitudinal beams 21-1 and 21-2 and, in so doing, one may adjust the placement of the grinding stone relative to the two vertical side surfaces of the ice skate blade mounted in ice skate mounting assembly 120. In the present embodiment, said adjusting mechanism may comprise a third mounting collar 181, an adjustable collar assembly 183, and a coil spring 185. Third mounting collar 181 may be fixedly mounted coaxially around second shaft 171 at a point proximate to a second end 174 of second shaft 171. Adjustable collar assembly 183, which may be coaxially mounted around second shaft 171, may comprise a first portion 184-1 and a second portion 184-2. First portion 184-1 may have an end in contact with annular bearing 177, and second portion 184-2 may be threadingly coupled to first portion 184-1 such that second portion 184-2 may be selectively screwed and unscrewed relative to first portion 184-1. Coil spring 185 may have one end compressed against third mounting collar 181 and an opposite end compressed against annular bearing 177. Consequently, by turning second portion 184-2, annular bearing 177 may be moved along the length of second shaft 171. As can be appreciated, the screwing or unscrewing of section portion 184-2 may be performed manually by the operator of sharpener 7; alternatively, one could automate such screwing or unscrewing.

Sharpener 7 may further comprise a housing 201. As seen best in FIG. 3(h), housing 201 may be used to hold certain components of sharpener 7. Housing 201 may be made up of one or more constituent parts and may comprise a drawer 203 which may be located along the bottom of housing 201 and which may be removably attached to the remainder of housing 201 to enable dust and other debris that may collect within drawer 203 to be removed. Annular bearing 159 may be fixedly mounted in an opening provided in a first side 205 of housing 201, and annular bearing 177 may be fixedly mounted in an opening provided in a second side 207 of housing 201. In this manner, housing 201 may be pivotally mounted about first shaft 151 and second shaft 171. An opening 209 may be provided along the top of housing 201 through which a grinding stone may partially extend.

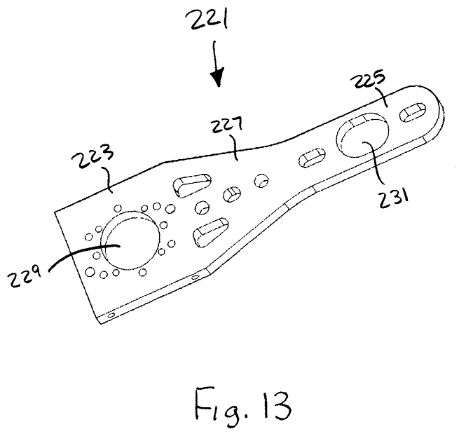

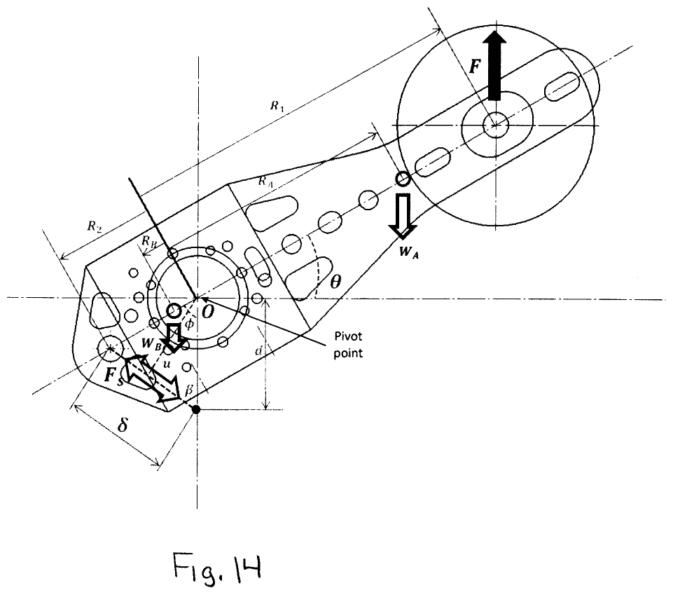

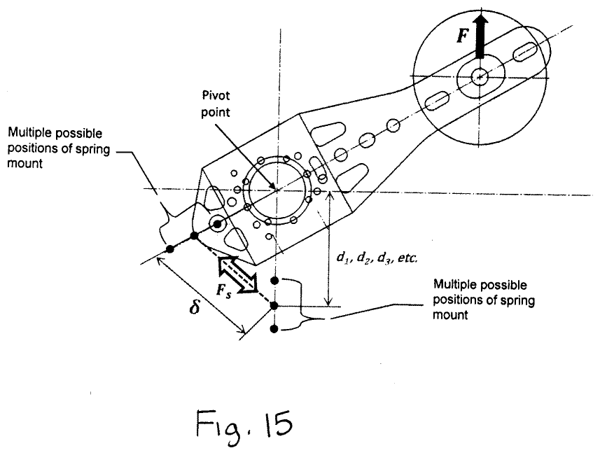

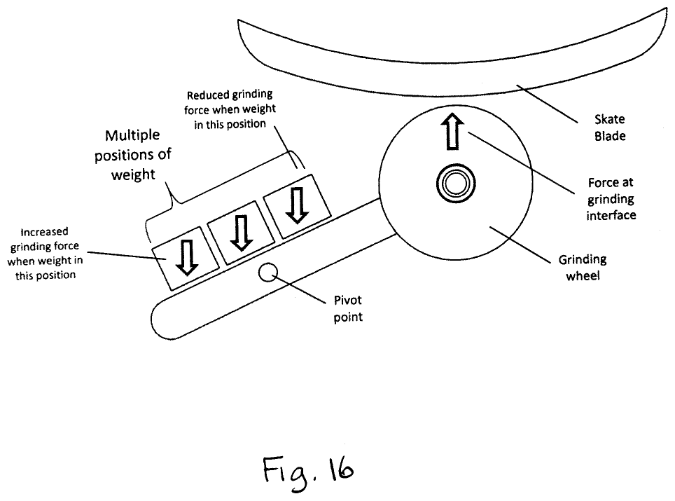

Sharpener 7 may further comprise a lever 221 (see, for example, FIG. 3(f)). Lever 221, which is also shown separately in FIG. 13, may be a unitary structure and may be made of a hard material, such as a hard polymer, metal, or other similarly suitable material. Lever 221 may be mounted in housing 201 and may be shaped to include a wide portion 223, a narrow portion 225, and an intermediate portion 227. A first transverse opening 229 may be provided in wide portion 223 of lever 221, and a second transverse opening 231 may be provided in narrow portion 225 of lever 221. First transverse opening 229 may be used to receive a motor shaft 235 of a motor 237 mounted within housing 201, the operation of motor 237 being controlled by compute device 9. Second transverse opening 231 may be used to receive a rotatable shaft 239 (see, for example, FIG. 3(h)) coupled to a grinding stone 241 mounted within housing 201. Shaft 235 may be coupled to shaft 239 by a combination of a belt 247 (see, for example, FIG. 3(f)) and a pair of pulleys, all of which may be mounted within housing 201. In the above manner, operation of motor 237 may cause the rotation of grinding stone 241. Alternatively, as will be discussed further below, instead of coupling grinding stone 241 to motor 237 through belt 247 and a pair of pulleys, motor 237 may be repositioned and grinding stone 241 may be mounted directly onto the shaft of motor 237. However, due to the weight of motor 237, some form of counterweight may be needed in order to help keep grinding stone 241 pushed upwardly towards the skate blade.

Sharpener 7 may further comprise a mechanism for dressing (i.e., reshaping) grinding stone 241. In the present embodiment, the dressing mechanism may be disposed within housing 201 and may comprise a dressing wheel 251 (see, for example, FIG. 3(h)), which may be, for example, a wheel of suitable shape (e.g., concave profile) covered in a highly abrasive material, such as Diamond grit. Dressing wheel 251 may be mounted on a moving platform 253, which may advance through a bearing block 255 on two spring-loaded shafts 257 using a lead screw 259. Lead screw 259 may be manually turned or may be automatically turned through some connection to compute device 9. Dressing wheel 251 may be advanced by a preset distance in order to reshape grinding stone 241 or may be advanced for a certain number of rotations once brought into contact with grinding stone 241. In another embodiment, instead of the above-described linear advancement arrangement, dressing wheel 251 may be mounted on the end of a pivoting arm.

As can be appreciated, after prolonged use and/or dressing, grinding stone 241 may wear down to an extent that it may need to be replaced. (Dressing wheel 251 may be used to detect when grinding stone 241 has been worn down beyond a predetermined threshold. Compute device 9 may then be used to signal the operator to change grinding stone 241.) To facilitate its replacement, grinding stone 241 may be removably mounted on rotatable shaft 239. To ensure that any grinding stone used in sharpener 7 is of suitable quality, grinding stone 241 may have an RFID or similar device affixed to a non-grinding surface thereof, and sharpener 7 may further comprise an RFID reader or similar reader that may be positioned within housing 201 or elsewhere and that may be coupled to compute device 9.

Sharpener 7 may further comprise a mechanism for maintaining constant pressure of grinding stone 241 against an ice skate blade that is mounted in ice skate mounting assembly 120. As seen best in FIG. 3(g), said mechanism may comprise a spring-loaded pivot mechanism.

According to one embodiment, said mechanism may comprise a first barrel 271 and a second barrel 273. First barrel 271 may be telescopingly mounted within second barrel 273. A first dowel 275 may be fixedly mounted proximate to an outer end 277 of first barrel 271, and a second dowel 279 may be fixedly mounted proximate to an outer end 281 of second barrel 273. A first extension spring 285 may be secured at one end to the top of first dowel 275 and may be secured at the opposite end to the top of second dowel 279. A second extension spring 287 may be secured at one end to the bottom of first dowel 275 and may be secured at the opposite end to the bottom of second dowel 279. A third barrel 291 may be coupled at one end to an intermediate portion of second barrel 273, i.e., at a first pivot point, and may be coupled at the opposite end to housing 201. A fourth barrel 293 may be coupled at one end to an intermediate portion of first barrel 271, i.e., at a second pivot point, and may be matingly coupled at an intermediate portion to a leadscrew 295 that, in turn, may be coupled to a turning knob 297. Extension springs 285 and 287 may have an extension past free length that is equal to the distance between where third barrel 291 is coupled to second barrel 273 and where fourth barrel 293 is coupled to first barrel 271. Turning knob 297, which may be connected to leadscrew 295, changes the distance between the second pivot point and the longitudinal axis of first shaft 151, which changes the amount of constant force that grinding stone 241 applies.

Referring now to FIG. 14 and to the discussion below, there is provided an explanation as to how grinding stone 241 applies constant force regardless of the angle of the main case:

Start with the summation of moments about pivot point O:

$$\sum {M}_{O} = 0 = {FR}_{1} cos θ + {F}_{s} u + {W}_{B} {R}_{B} cos θ - {W}_{A} {R}_{A} cos θ \qquad ( EQ . 1 )$$

Where, by law of cosines,

$${F}_{s} = K δ and δ = \sqrt{{R}_{2}^{2} + {d}^{2} - 2 {R}_{2} d cos ϕ}$$

And, by law of sines,

$$u = d sin β , where β = {sin}^{- 1} [ \frac{{R}_{2}}{δ} sin ϕ ] from \frac{u}{sin β} = \frac{δ}{sin β}$$

Back substitution yields

$$u = d \frac{{R}_{2}}{δ} sin ϕ ∴ {F}_{s} = k δ \cdot d \frac{{R}_{2}}{δ} sin ϕ = {KdR}_{2} cos θ , since ϕ = \frac{π}{2} - θ$$

Substitution of Fₛ into Equation 1 yields, when rearranged

$${FR}_{1} cos θ = [ {W}_{A} {R}_{A} - {W}_{A} {R}_{B} - {KdR}_{2} ] cos θ$$

Therefore, the desired upward force F at the grinding wheel is independent of the angle of the arm

$$F = {W}_{A} \frac{{R}_{A}}{{R}_{1}} - {W}_{B} \frac{{R}_{B}}{{R}_{1}} - Kd \frac{{R}_{2}}{{R}_{1}}$$

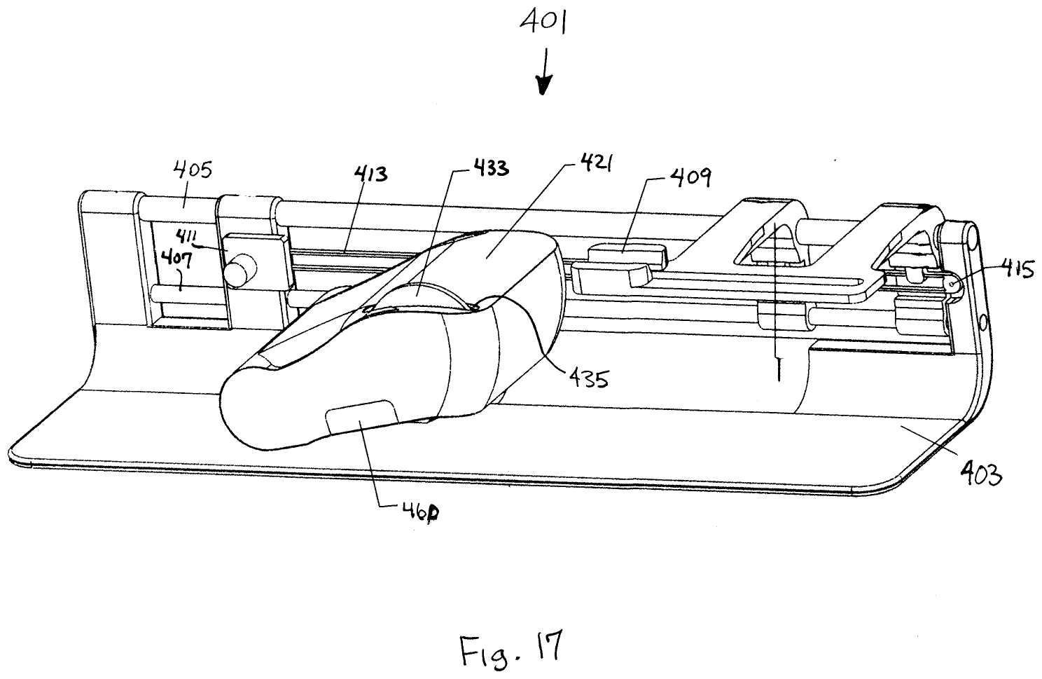

The amount of force applied by grinding stone 241 to the ice skate blade may be adjusted between passes of the skate blade past the grinding stone in order to permit one to obtain more coarse or more fine sharpening of the skate blade. As seen in FIG. 15, this may be done by changing the location of one or both of the spring pivot mounts. The relative distance between the spring pivot points may be increased in order to increase the grinding force or may be decreased to reduce the grinding force. It can be appreciated that the pivot points can be moved so long as the design principles of the constant force mechanism are preserved, and it can further be appreciated that the adjustment may be infinitely variable. The mechanism may be constructed such that an operator may choose the force level by adjusting a knob, a lever, or other similar device that changes the distance between pivots. Alternatively, the pivot distance may be set automatically or semiautomatically by a motor or motors which adjust one or both pivot locations by means of a lead screw, rack and pinion, drive belt, cable drive, or other mechanism. Alternatively, the back and forth motion of the skate relative to the pivot arm may be used to drive, directly or indirectly, a mechanism which changes the position of one or both pivots such that the force is increased or decreased with successive passes of the skate as desired. This mechanism may also be connected to the skate motion such that the pivot location is only increased or decreased when the skate travels beyond some range of travel.

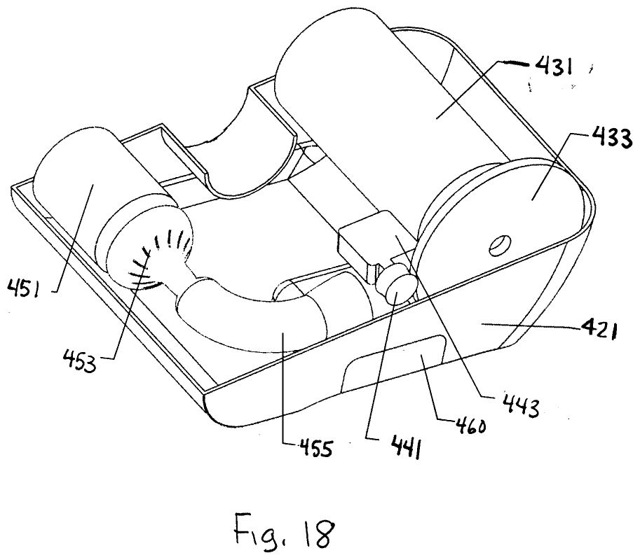

FIG. 16 shows an alternate mechanism to that disclosed in FIG. 15. In FIG. 16, adjustment of the grinding force is provided through the use of a variably positioned counterweight on a skate sharpening pivot assembly. The counterweight may be positioned in various positions, either contributing to an increase in force at the grinding stone/skate blade interface or contributing to a decrease in grinding force by virtue of weighing down the pivot arm. It can be appreciated that both the weight and position of the counterweight will have an effect on force at the grinding interface and that the force may be infinitely variable. The mechanism may be constructed such that an operator may choose the counterweight effect by positioning the weight relative to the pivot arm. Alternatively, the position may be determined automatically or semi-automatically by a motor which drives the weight to any location by means of a lead screw, rack and pinion, drive belt, cable drive, or other mechanism. Alternatively, the back and forth motion of the skate relative to the pivot arm may be used to drive, directly or indirectly, a mechanism which changes the position of the weight such that the counterbalance is increased or decreased with successive passes of the skate as desired. This mechanism may also be connected to the skate motion such that the counterbalance force is only increased or decreased when the skate travels beyond some range of travel.

In general, to use sharpener 7, an operator may secure an ice skate to ice skate mounting assembly 120 and then may actuate motors 113 and 237, whereby the ice skate may be moved towards and across the rotating grinding stone 241 in one or more coarse and/or fine passes in forward and/or reverse directions. The operation of motors 113 and 237 may be jointly or independently controlled through compute device 9. Grinding stone 241 may periodically be dressed by dressing wheel 251. Such dressing may be performed before each pass of the ice skate across grinding stone 241 or may be performed after a selected number of passes. The operation of dressing wheel 251 may be controlled through compute device 9. After an ice skate has been sharpened using sharpener 7, the squareness of the ice skate blade may be assessed using a conventional skate squareness checker and/or using a skate squareness checker as hereinafter described. Depending on the determined squareness of the ice skate blade, the settings on sharpener 7 may be manually and/or automatically modified (for example, by adjusting adjustable collar assembly 183 to reposition grinding stone 241 relative to the width of the ice skate blade), and the ice skate may once again be sharpened using sharpener 7. Compute device 9 may provide recommendations as to how the settings on sharpener 7 may be modified to compensate for a lack of squareness. The foregoing process may be repeated as needed.

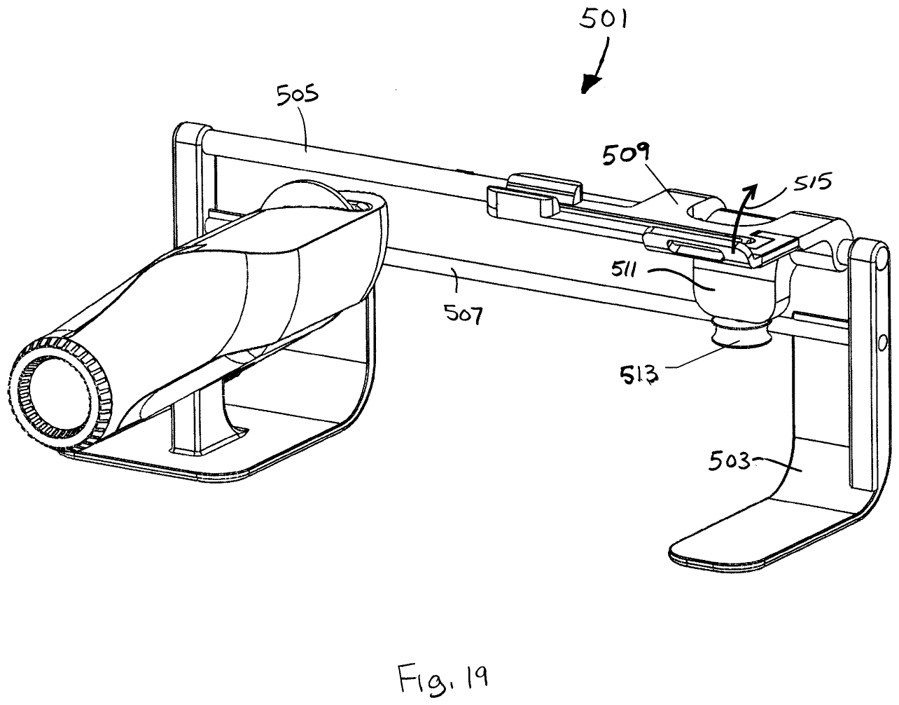

As noted above, in sharpener 7, ice skate mounting assembly 120 may be mechanically coupled to rails 71 and 73, and rails 71 and 73 may be made to slide relative to base 13. An alternative arrangement is depicted in FIG. 17, which is directed generally at a first alternate skate sharpener 401.

Sharpener 401 may comprise a base 403, a pair of rails 405 and 407 that may be fixedly mounted on base 403, and a skate holder 409 that may be slidably mounted on rails 405 and 407. Slidable movement of skate holder 409 on rails 405 and 407 may be effected by a motor 411 that may be coupled to skate holder 409 by a skate holder belt 413 and a pulley 415, skate holder 409 being coupled to skate holder belt 413.

Sharpener 401 may further comprise a housing 421, the contents of which are shown in FIG. 18. A motor 431, the operation of which may be controlled by compute device 9, may be disposed within housing 421. A grinding stone 433, which may be seated in housing 421 and which may extend partially through a slot 435 in housing 421, may be operatively coupled to motor 431. A dressing wheel 441 may be disposed within housing 421 and may be selectively brought into contact with grinding stone 421 using an actuator 443. Operation of actuator 443 may be controlled by compute device 9. A vacuum motor 451 may be seated within housing 421. Operation of vacuum motor 451 may be controlled by compute device 9. Vacuum motor 451 may be operatively connected to a vacuum impeller 453, which may also be disposed within housing 421. A length of vacuum tubing 455 may be disposed within housing 421, one end of tubing 455 being operatively coupled to impeller 453 and the other end of tubing 455 being disposed in proximity to dressing wheel 441. Housing 421 may include a removable drawer 460.

Although not shown, sharpener 401 may include a mechanism similar to that described above in connection with sharpener 7 for maintaining constant pressure of grinding stone 433 against an ice skate blade that is mounted in skate holder 409.

Referring now to FIG. 19, there is shown a second alternate skate sharpener to skate sharpener 7, the second alternate skate sharpener being represented generally by reference numeral 501.

Sharpener 501 may comprise a base 503, a pair of rails 505 and 507 that may be fixedly mounted on base 503, and a skate holder 509 that may be slidably mounted on rails 505 and 507. Slidable movement of skate holder 509 along rails 505 and 507 may be effected by a motor 511 that may drive a friction wheel 513 in contact with rail 507. Operation of motor 511 may be controlled by compute device 9. Skate holder 509 may be pivotable away from rails 505 and 507 in the direction indicated by arrow 515 to permit the examination of the bottom of an ice skate blade mounted in skate holder 509 either manually or using skate squareness checker 8.

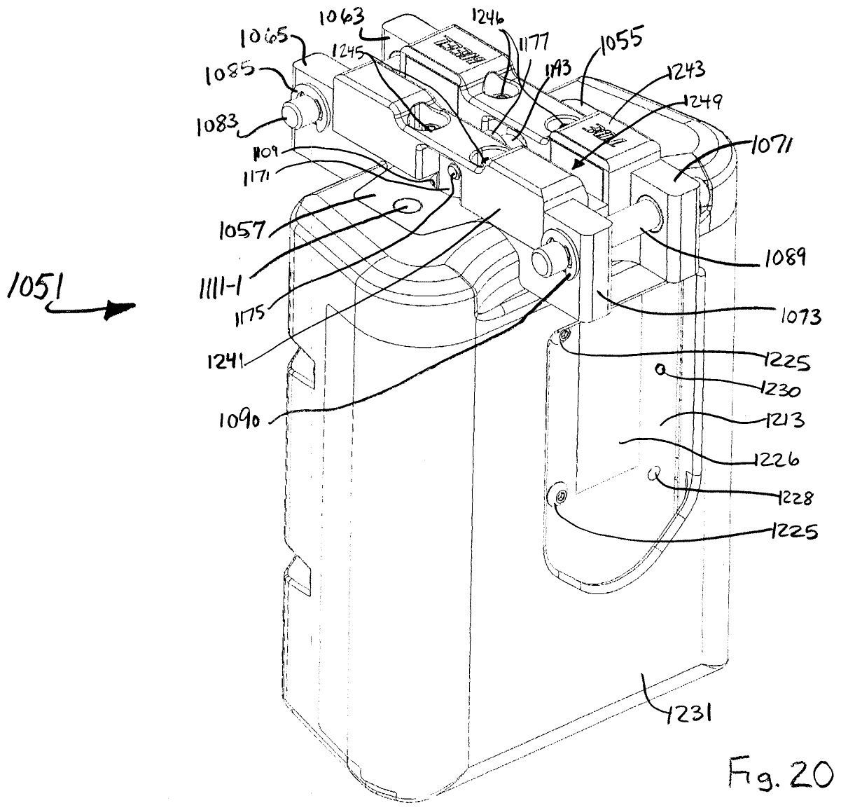

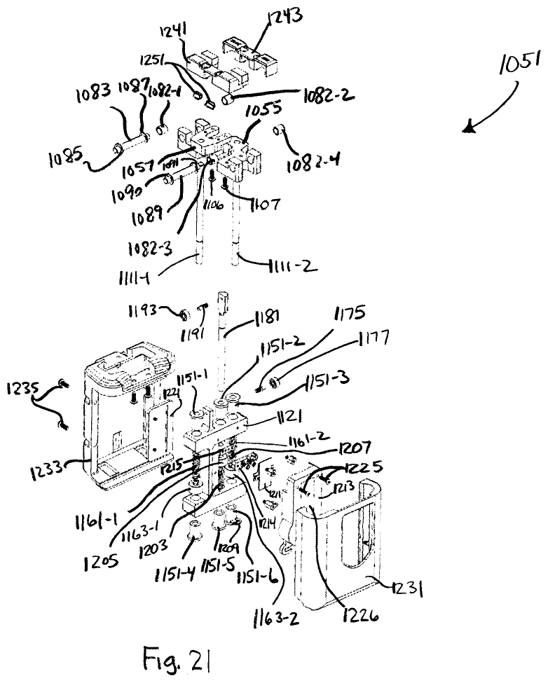

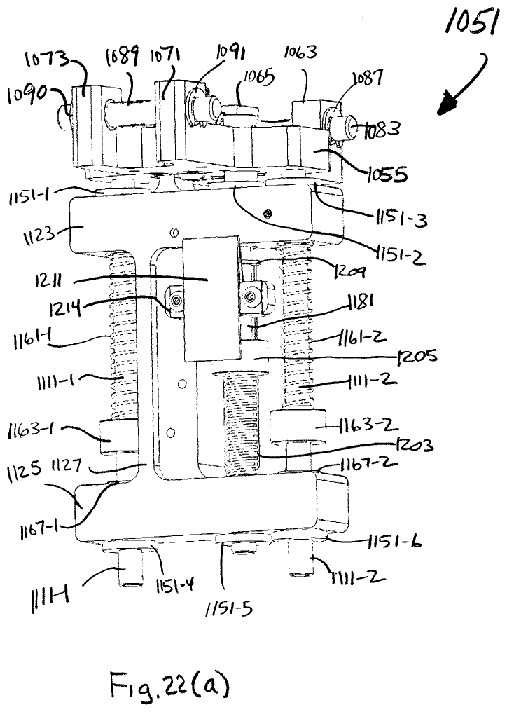

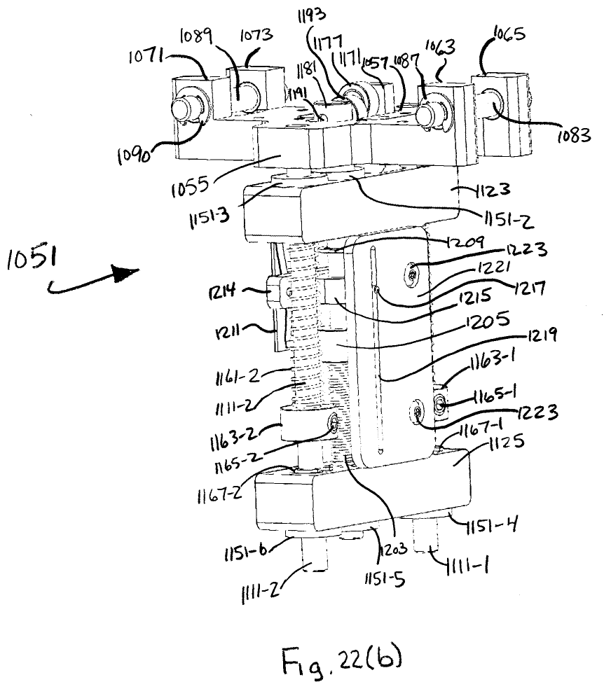

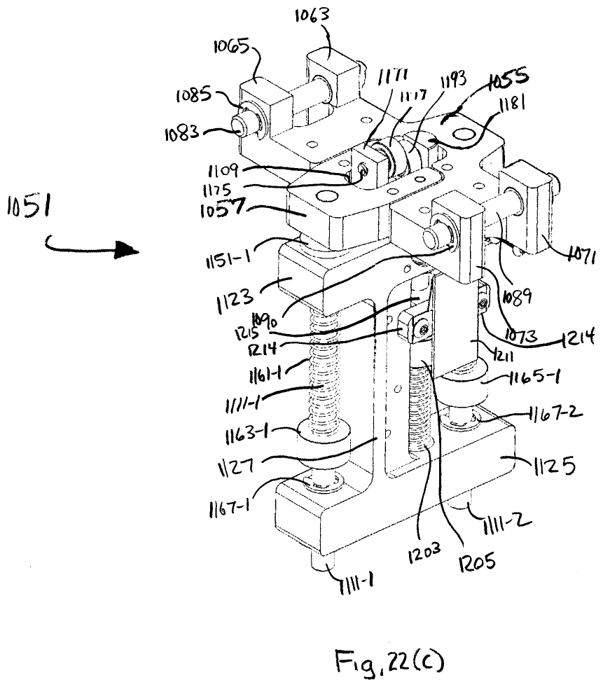

Referring now to FIGS. 20, 21, and 22(a) through 22(c), there are shown various views of a first embodiment of skate squareness checker 8.

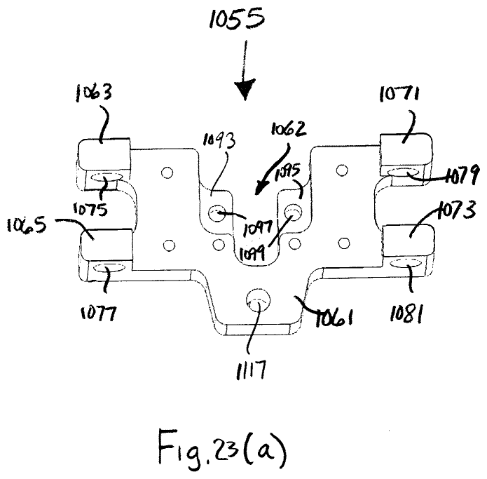

Checker 8 may comprise a first support member 1055 and a second support member 1057. First support member 1055, which is also shown separately in FIGS. 23(a) and 23(b), may be a unitary structure and may be made of a hard material, such as a hard polymer, metal, ceramic, or other similarly suitable material. First support member 1055 may be shaped to include a planar portion 1061, which, when viewed from above, may be generally C-shaped and which may define a transverse slot 1062, which may be generally U-shaped. A first set of posts 1063 and 1065 may extend upwardly a short distance from one end of planar portion 1061, and a second set of posts 1071 and 1073 may extend upwardly a short distance from the opposite end of planar portion 1061. Posts 1063, 1065, 1071, and 1073 may be similar in size and shape to one another. Posts 1063 and 1065 may have bores 1075 and 1077, respectively, that may be aligned with one another, and posts 1071 and 1073 may have bores 1079 and 1081, respectively, that may be aligned with one another. Bearing bodies 1082-1 through 1082-4, each of which may be a generally tubular member having a low-friction inner surface, may be fixedly and coaxially mounted in bores 1075, 1077, 1079, and 1081, respectively. A roller 1083 may be rotatably mounted in bearing bodies 1082-1 and 1082-2 using a pair of e-clips 1085 and 1087, and a roller 1089 may be rotatably mounted in bearing bodies 1082-3 and 1082-4 using a pair of e-clips 1090 and 1091. As will be discussed further below, rollers 1083 and 1089 may be used to contact a skate blade while the evenness of the skate blade is being determined by checker 8.

First support member 1055 may be further shaped to include a pair of recessed tabs 1093 and 1095 that may extend from planar portion 1061 partially into slot 1062. Tab 1093 may have a transverse opening 1097, and tab 1095 may have a transverse opening 1099. As will be discussed further below, tabs 1093 and 1095 may be used to couple together first support member 1055 and second support member 1057.

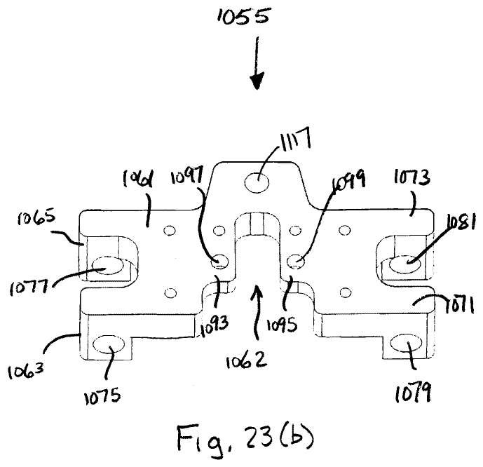

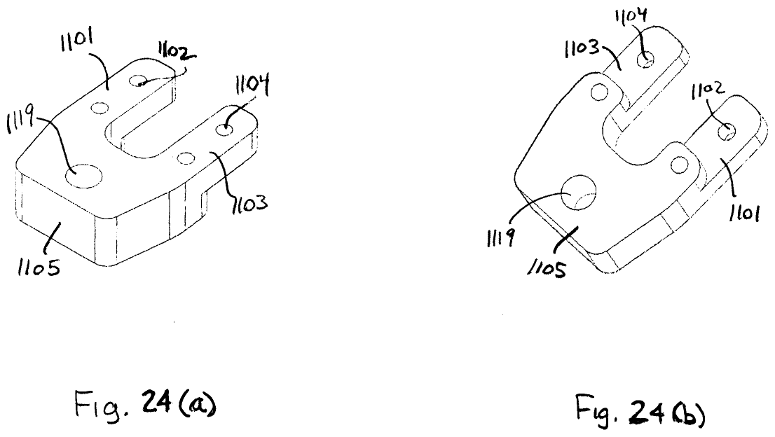

Second support member 1057, which is also separately shown in FIGS. 24(a) and 24(b), may be a unitary structure and may be made of a hard material, such as a hard polymer, metal, ceramic, or other similarly suitable material. Second support member 1057 may be generally U-shaped and may include a first arm 1101, a second arm 1103, and a connector 1105. The free ends of first arm 1101 and second arm 1103 may be appropriately dimensioned to sit upon tabs 1093 and 1095, respectively, of first support member 1055, and first arm 1101 and second arm 1103 may have openings 1102 and 1104, respectively, that may be aligned with openings 1097 and 1099, respectively, of first support member 1055. In this manner, first support member 1055 and second support member 1057 may be joined together with a first screw 1106 inserted through openings 1097 and 1102 and a second screw 1107 inserted through openings 1099 and 1104. Thus joined, first support member 1055 and second support member 1057 may jointly define a slot 1109, which may be generally oval when viewed from above.

It should be understood that, whereas, in the present embodiment, first support member 1055 and second support member 1057 are separate pieces joined together with screws 1106 and 1107, one could replace first support member 1055 and second support member 1057 with a unitary structure.

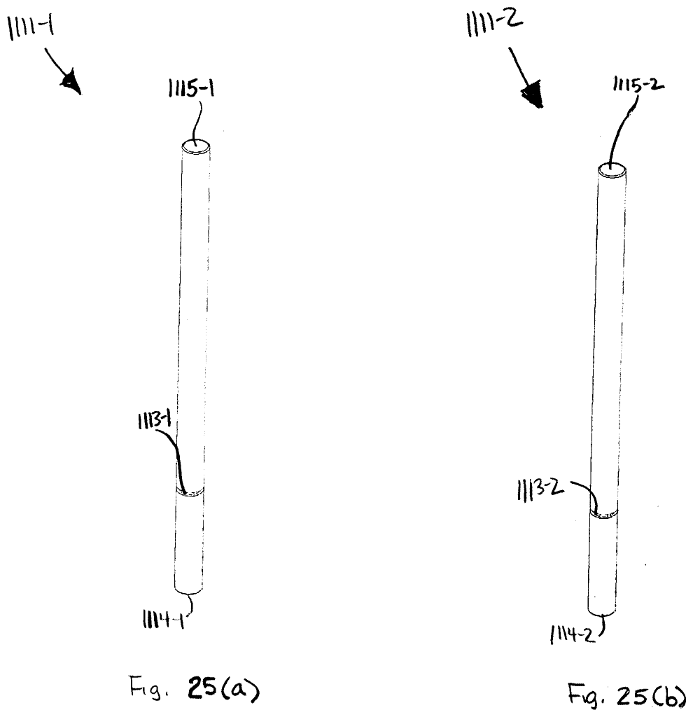

Checker 8 may further comprise a pair of posts 1111-1 and 1111-2, which may be identical to one another and which are also shown separately in FIGS. 25(a) and 25(b), respectively. Each of posts 1111-1 and 1111-2 may be a unitary structure and may be made of a hard metal or other similarly suitable material. Post 1111-1 may be generally cylindrical in shape and may include a waist portion 1113-1 of narrowed diameter proximate to a bottom end 1114-1, and post 1111-2 may be generally cylindrical in shape and may include a waist portion 1113-2 of narrowed diameter proximate to a bottom end 1114-2. Post 1111-1 may have an upper end 1115-1 that may be fixedly mounted within an opening 1117 in first support member 1055, and post 1111-2 may have an upper end 1115-2 that may be fixedly mounted within an opening 1119 in second support member 1057.

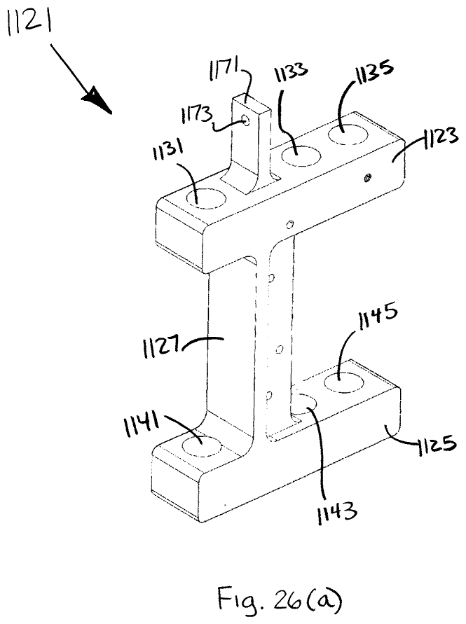

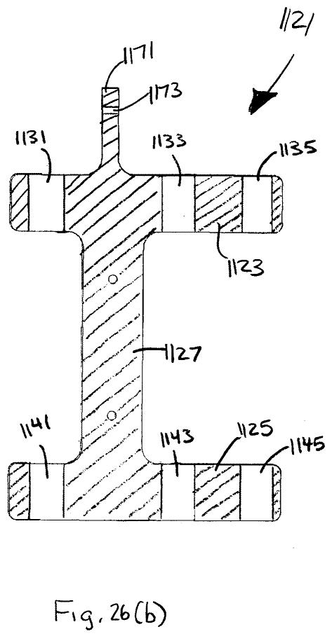

Checker 8 may further comprise a carriage 1121. Carriage 1121, which is also shown in FIGS. 26(a) and 26(b), may be a unitary structure and may be made of a hard material, such as a hard polymer, metal, or other similarly suitable material. Carriage 1121, which may be generally I-shaped, may be shaped to comprise an upper member 1123, a lower member 1125, and a connecting member 1127. A series of transverse bores 1131, 1133, and 1135 may be provided in upper member 1123, and a corresponding series of transverse bores 1141, 1143, and 1145 may be provided in lower member 1125 such that bores 1131 and 1141 may be aligned with one another, bores 1133 and 1143 may be aligned with one another, and bores 1135 and 1145 may be aligned with one another. Bearing bodies 1151-1 through 1151-6, each of which may be a tubular member having a low-friction inner surface, may be fixedly and coaxially mounted in bores 1131, 1133, 1135, 1141, 1143, and 1145, respectively.

Post 1111-1 may be positioned so as extend through bearing bodies 1151-1 and 1151-4, and post 1111-2 may be positioned so as to extend through bearing bodies 1151-3 and 1151-6, whereby carriage 1121 may be slidably mounted on posts 1111-1 and 1111-2. Carriage 1121 may be biased upwardly on posts 1111-1 and 1111-2 by a pair of springs 1161-1 and 1161-2. More specifically, spring 1161-1 may be mounted coaxially around post 1111-1 between upper member 1123 and a collar 1163-1 that may be fixed to post 1111-1 with a tightening screw 1165-1, and spring 1161-2 may by mounted coaxially around post 1111-2 between upper member 1123 and a collar 1163-2 that may be fixed to post 1111-2 with a tightening screw 1165-2. E-clips 1167-1 and 1167-2 may be fixedly mounted on waist portions 1113-1 and 1113-2 of posts 1111-1 and 1111-2, respectively, to limit upward movement of carriage 1121 relative to posts 1111-1 and 1111-2.

Carriage 1121 may be shaped to further comprise a tab 1171 that may extend upwardly a short distance from upper member 1123 and through slot 1109. Tab 1171 may be shaped to include a transverse opening 1173. A shaft 1175 may be coaxially mounted and secured within opening 1173, and a master roller 1177 may be rotatably mounted on shaft 1175. For reasons to become apparent below, roller 1177 may extend upwardly through slot 1109 and may be positioned vertically relative to rollers 1083 and 1089 such that roller 1177 is slightly higher than rollers 1083 and 1089. As force is applied to roller 1177, for example as a result of contacting roller 1177 with a skate blade contact edge, carriage 1121 may be caused to slide along posts 1111-1 and 1111-2 in a direction away from first support member 1055 and second support member 1057.

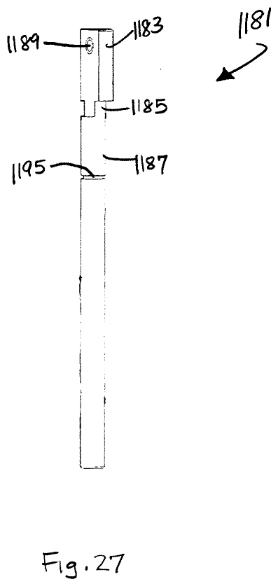

Checker 8 may further comprise a plunger 1181. Plunger 1181, which is also shown separately in FIG. 27, may be a unitary structure and may be made of a hard metal or other similarly suitable material. Plunger 1181, which may be a generally rod-shaped structure, may be shaped to comprise an upper portion 1183, an intermediate portion 1185, and a lower portion 1187. Upper portion 1183 and intermediate portion 1185 may be generally semi-cylindrical in shape, with upper portion 1183 having a greater diameter than intermediate portion 1185. Lower portion 1187 may be generally cylindrical in shape and may have a diameter generally equal to that of intermediate portion 1185. Upper portion 1183 may be shaped to include a transverse bore 1189. A shaft 1191 may be coaxially mounted and secured within bore 1189, and a slave roller 1193 may be rotatably mounted on shaft 1191. For reasons to become apparent below, roller 1193 may extend upwardly through slot 1109 and may be positioned vertically relative to rollers 1083 and 1089 such that roller 1193 is slightly higher than rollers 1083 and 1089 but slightly lower than roller 1177. Lower portion 1187 may be shaped to include a waist portion 1195 of narrowed diameter proximate to intermediate portion 1185.

Plunger 1181 may be appropriately dimensioned to extend through bearing bodies 1151-2 and 1151-5 and upwardly through slot 1109 and may be slidable up and down relative to carriage 1121. Plunger 1181 may be biased upwardly relative to carriage 1121 by a spring 1203. More specifically, spring 1203 may be mounted coaxially around plunger 1181 between lower member 1125 of carriage 1121 and a collar 1205 that may be fixed to plunger 1181 with a tightening screw 1207. An e-clip 1209 may be secured to waist 1195 of plunger 1181 to limit upward movement of plunger 1181 relative to carriage 1121.

Checker 8 may further comprise a capacitive measurement circuit, which capacitive measurement circuit may, in turn, comprise an electrode stator 1211 and a reading unit 1213. Electrode stator 1211 may be a conventional electrode stator of the type found in conventional digital calipers, and reading unit 1213 may be a conventional reading unit of the type found in conventional digital calipers, whereby electrode stator 1211 and reading unit 1213 may function together in the manner described further below to measure the evenness of a skate blade through a capacitive measurement circuit of the type conventionally found in digital calipers. (It should be understood that, although a capacitive measurement circuit is specifically referenced above, any means that can be used to provide a sufficiently high resolution displacement reading, with preferably a resolution of at least 0.002 inch, can be employed. Examples of such alternative means may include a magnetic incremental scale or a linear potentiometer.) Electrode stator 1211 may be fixedly mounted on a plate 1214. Plate 1214, in turn, may be fixedly mounted on a collar 1215 that may be fixedly and coaxially mounted around plunger 1181. In this manner, as plunger 1181 moves up or down relative to carriage 1121, so does electrode stator 1211. In order to prevent rotation of plunger 1181 about its longitudinal axis, a pin 1217 facing away from electrode stator 1211 may be fixed to collar 1215 and may travel within a slot 1219 provided in a guide 1221 secured to carriage 1121 with screws 1223. Reading unit 1213 may be fixed to carriage 1121 with screws 1225. Consequently, in view of the above, as force is applied to roller 1193, for example as a result of contacting roller 1193 with a skate blade contact edge, electrode stator 1211 may be moved vertically relative to reading unit 1213. Reading unit 1213 may include a display 1226 for displaying the measured evenness of a skate blade and may additionally include a compute device and one or more control buttons, such as an on/off button 1228 and a zero button 1230.

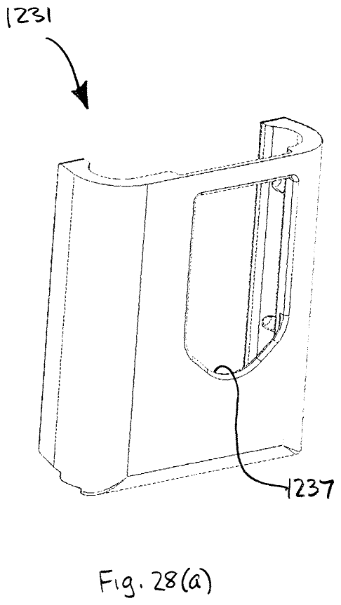

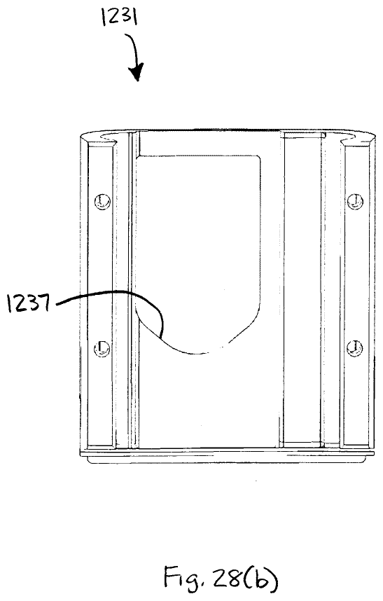

Checker 8 may further comprise a front housing portion 1231, which may be shown separately in FIGS. 28(a) and 28(b), and a rear housing portion 1233, which may be shown separately in FIGS. 29(a) and 29(b). Front housing portion 1231 and rear housing portion 1233 may be joined to one another with screws 1235 to define a cavity that may house several of the components of device 151. Front housing portion 1231 may include a window 1237 through which display 1226 may be viewed and through which buttons 1228 and 1230 may be accessed.

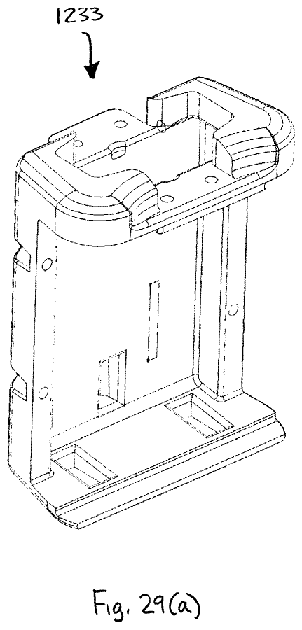

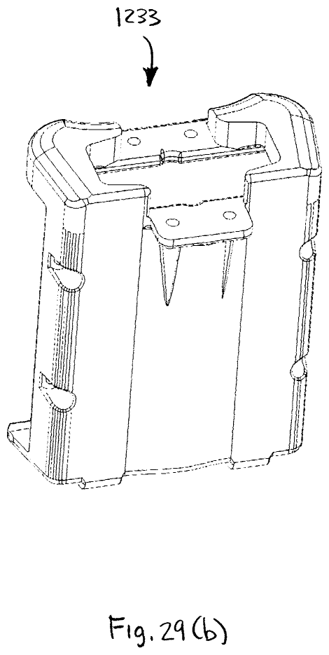

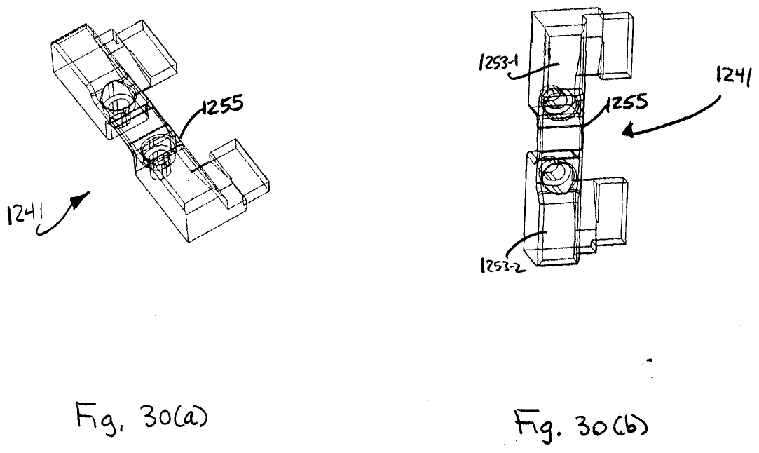

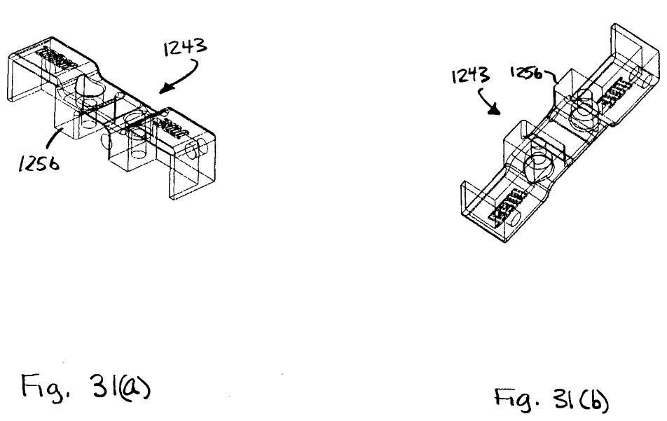

Checker 8 may further comprise a left blade guide 1241, which may be shown separately in FIGS. 30(a) and 30(b), and a right blade guide 1243, which may be shown separately in FIGS. 31(a) and 31(b). Left blade guide 1241 may be secured to the top of second support member 1057 by screws 1245, and right blade guide 1243 may be secured to the top of first support member 1055 by screws 1246. Left blade guide 1241 and right blade guide 1243 may jointly define a slot 1249 positioned over rollers 1177 and 1193 that may receive a skate blade. One or more magnets 1251 may be positioned within cavities in left blade guide 1241, for example, within a pair of cavities 1253-1 and 1253-2 provided in left blade guide 1241, to help keep a skate blade flush against a wall 1255 of left blade guide 1241. (Magnets 1251 may alternatively or additionally be positioned within similar cavities that may be provided in right blade guide 1243 to keep the skate blade flush against a side wall 1256 of right blade guide 1243.) Alternatively, instead of using magnets 1251, one could keep a skate blade flush against wall 1255 using other means, such as, but not limited to, a locking screw, a clamp, a spring-loaded lever, a spring clip, or the like.

In use, checker 8 may be inverted, whereby blade guides 241 and 243 may face downwardly, as opposed to facing upwardly as in FIG. 20. The skate blade whose evenness is being measured may also be inverted, whereby its contact edges may face upwardly, as opposed to facing downwardly towards an ice surface. With checker 8 and the skate blade thus oriented, the skate blade may be loaded into checker 8 by inserting the skate blade into the slot 1249 between left blade guide 1241 and right blade guide 1243, with the leading and trailing ends of the skate blade preferably in contact with rollers 1083 and 1089, respectively, or vice versa. The skate blade may be positioned within slot 249 such that one of the vertical side surfaces of the skate blade may lie flush against wall 1255 of left blade guide 1241 (or wall 1256 of right blade guide 1243), whereby one of the contact edges of the skate blade is in contact with roller 1177 and the other contact edge of the skate blade is in contact with roller 1193. In this manner, the contact edge of the blade that is in contact with roller 1177 may cause carriage 1121 to be displaced upwardly by a first distance, and the contact edge of the blade that is in contact with roller 1193 may cause plunger 1181 to be displaced upwardly by a second distance. If the contact edges of the blade are even, roller 1177 and roller 1193 may be moved upwardly until both lie flush with rollers 1083 and 1089. On the other hand, if the contact edges of the blade are uneven, one of rollers 1177 and 1193 may lie flush with rollers 1083 and 1089 whereas the other of rollers 1177 and 1193 will not lie flush with rollers 1083 and 1089. Because electrode stator 1211 is mechanically coupled to plunger 1181 and because reading unit 1213 is mechanically coupled to carriage 1121, the relative positions of electrode stator 1211 and reading unit 1213 may reflect the difference, if any, in height between the two contact edges. It should be noted that, prior to using checker 8 on a skate blade whose evenness is unknown, checker 8 is preferably calibrated or “zeroed.” This may be done by loading into checker 8 a reference blade whose contact edges are known to be even and then “zeroing” the reading unit 1213 where the electrode stator 1211 is thus positioned. In this manner, it is the change in relative positions of electrode stator 1211 and reading unit 1213 from the reading involving the reference blade to the reading involving the blade in question that indicates the evenness of the blade in question.

In accordance with the teachings of the present disclosure, the reference blade used to “zero” checker 8 may take any of a variety of different forms. For example, the reference blade may be pivotally mounted on checker 8 in such a way that it may be rotated into place. Alternatively, the reference blade may be located internally to checker 8 and may use features on shafts 1175 and 1191 that are known distances from rollers 1177 and 1193. Alternatively, the reference blade may be an external component that may be manually loaded into checker 8, or the reference blade may be mounted on the top of checker 8 and slid into place. Alternatively, a reference blade feature may be incorporated into sharpener 7. This would give sharpener 7 a fixed location where checker 8 could be docked and “zeroed.” For example, the reference blade may be positioned on a skate holder platform of sharpener 7. This would put the reference blade in the same general area as the blade which is to be measured and would be very convenient for the user. Alternatively, the device may be zeroed without the use of a reference blade by incorporating into the electronic circuit a known offset distance between electrode stator 1211 and reading unit 1213 when they are in the free, non-measuring position such that, when the operator initiates calibration, this offset is used to calculate the true relative distance between electrode stator 1211 and reading unit 1213.

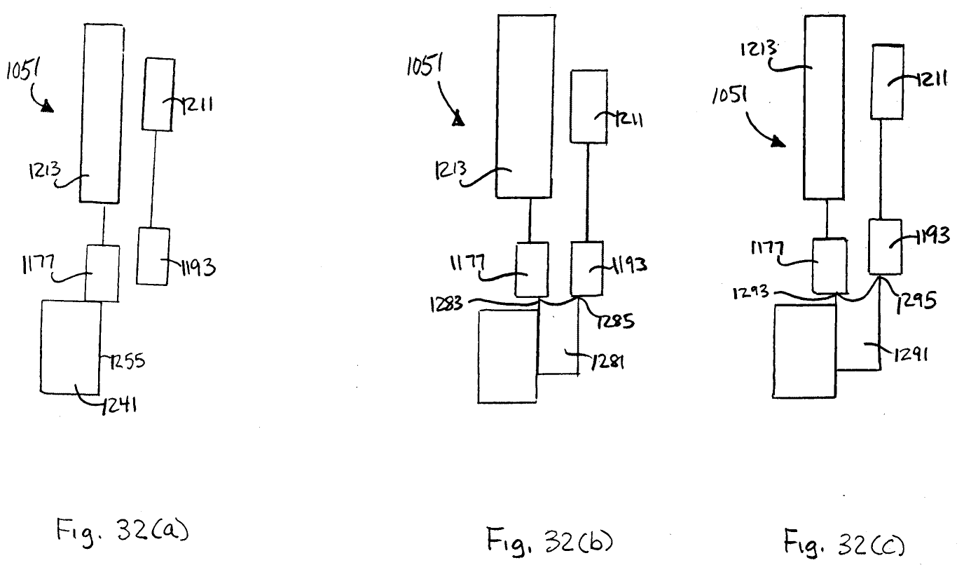

FIGS. 32(a) through 32(c) are schematic diagrams that illustrate, in part, the operation of checker 8. In particular, FIG. 32(a) shows checker 8 prior to use, FIG. 32(b) shows checker 8 being used, presumably after having been zeroed, with a skate blade 1281 whose contact edges 1283 and 1285 are even, and FIG. 32(c) shows checker 8 being used, presumably after having been zeroed, with a skate blade 1291 whose contact edges 1293 and 1295 are uneven. A comparison of each of FIGS. 32(b) and 32(c) to FIG. 32(a) illustrates the various movements of rollers 1177 and 1193, electrode stator 1211, and reading unit 1213 that result from the loading of skate blades 1281 and 1291 into checker 8. As can be seen from FIGS. 32(b) and 32(c), the contact edge of the skate blade that lies nearer to left blade guide 1241, i.e., edges 1283 and 1293, essentially establishes a frame of reference against which the contact edge of the skate blade that lies farther from left blade guide 1241, i.e., edges 1285 and 1295, moves.

An important feature of the present disclosure relates to the capability of the device to process the measurement information obtained thereby. No other device is known to the present inventor that measures the squareness of a skate blade using embedded electronics. The electronic measurement and processing of the data in accordance with the present disclosure offers several advantages to existing devices. For example, it is important to recall that the measurement of the evenness of the contact edges of a skate blade is typically done to enable an operator of a skate sharpening machine to adjust the sharpening machine to bring the skate blade edges back to equal heights. This is usually done by moving the center plane of the grinding stone into alignment with the center plane of the skate blade, or vice versa. Once the skate blade edge offset is known, a calculation of how much the skate blade or the grinding stone needs to be adjusted is dependent on several factors. These factors include the skate blade width and the radius or shape on the edge of the grinding stone. According to the present disclosure, the foregoing parameters can be entered into the device by a user, which will allow the device not only to display the amount of edge offset but also to give an accurate amount of skate blade or grinding stone adjustment that is needed to make the edges back on the next grinding stone pass. This adjustment information is only possible if the device understands the relationship between an adjustment amount on a skate sharpening machine and the movement of the skate blade/grinding stone interface. This information may be regarded as “the adjustment factor” for a skate sharpening machine. Once this factor is known, the device can recommend an adjustment amount that, by its calculations, should bring the contact edge heights back to being equal.

Another important feature of the present disclosure is the capability of the device to “learn.” According to the present disclosure, the device may make a recommendation on an adjustment and then may prompt the user to confirm if the adjustment was made prior to a second measurement. If the second measurement is not what the device anticipated, the adjustment factor within the device algorithm is modified to better represent the relationship between adjustment amount on the skate sharpening machine and the movement of the skate blade/grinding stone interface. From this stage, future recommended skate sharpener adjustments will be more accurate.

A benefit of processing the edge height measurements is the capability of the device to process multiple measurements into a single result. Oftentimes, an individual will measure the edge height difference at the toe, midfoot, and heel of the skate blade. Depending on the blade's straightness and the sharpening machine's trueness (i.e., the extent to which the skate moves perfectly parallel to the grinding wheel throughout its motion), the measurements can be different at each location. The present disclosure enables a user to make any number of measurements, such as three measurements (e.g., toe, midfoot, heel), and to receive one adjustment recommendation that takes into account the three measurements. In the case of a bent skate blade, this recommended adjustment can bring the skate blade into the best possible overall edge evenness following a sharpening without having to replace the blade. The present state of the art in edge checking leaves the user with having to estimate what would be the best adjustment based on multiple, and oftentimes different, measurements.

In short, existing blade measuring devices require a user to visually interpret a measurement. Such measurements are often not straightforward to make. They often involve physically small graduations on a ruler-like device, graduations that are not numbered, with gaps between adjacent parts, etc. Such a task requires a keen eye, consistent interpretation, and an understanding of how the measurement device works. A goal of the present disclosure is to bring skate sharpening to the masses. Presently, skate sharpening is a process that is relegated to a select few experts. These experts are usually the individuals that own or work at ice skating equipment stores. In order to bring the sharpening process to the masses, the measurement of edge height needs to be simple. Furthermore, existing devices do not provide a user with instructions on how to adjust a skate sharpening machine in order to correct unevenness in blade height.

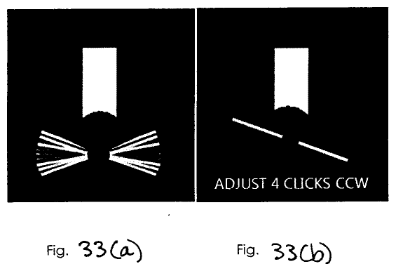

The present disclosure takes what was once a nuanced, skilled art, namely, edge measurement, and makes it a simple process. The present disclosure makes it simple for a user to connect the present device to a skate and to read a display that indicates precisely, either through a numerical representation (e.g., degrees of angle or numerical height offset) or through a graphic depiction, the evenness of the skate contact edges and/or that indicates what type of adjustment should be made to a skate sharpening machine to make the contact edges even. For example, FIG. 33(a) is a graphic depiction of a square skate blade whereas FIG. 33(b) is a depiction of an uneven skate blade. In the case of the even skate blade of FIG. 33(a), one or more of the more horizontal segments (here shown in green) would be illuminated whereas, in the case of an uneven blade, one or more of the more sloped segments (shown in red) would illuminate. Yellow segments would indicate an amount of unevenness to have concern over but not necessarily that need to be dealt with immediately. FIG. 33(b) is an example of a depiction of an uneven skate blade. This is a very unambiguous reading for the user. The user would graphically see that the blade has a high right edge and that the way to fix this problem is to rotate an adjustment knob on the sharpener “4 clicks” in the counter-clockwise direction.

Yet another advantage of the present disclosure is that checker 8 permits the use of a single measurement circuit. By having roller 1177 reference one of the two contact edges of the skate blade while roller 1193 references the other of the two contact edges of the skate blade, checker 8 measures the relationship between the two contact edges, as opposed to measuring the heights of both edges and then subtracting to get a difference measurement. In order for this occur, checker 8 first fixes the face of the blade. Then, roller 1177 rises up to “touch” the first contact edge. Roller 1193 then moves relative to the first contact edge. Since there was a zeroing step performed prior to the measurement which defined the offset zero point, only a single height measurement needs to take place in order to determine the relative height difference of the two edges. This minimizes the electronics (cuts the amount of electronics in half) and simplifies the mechanism components.

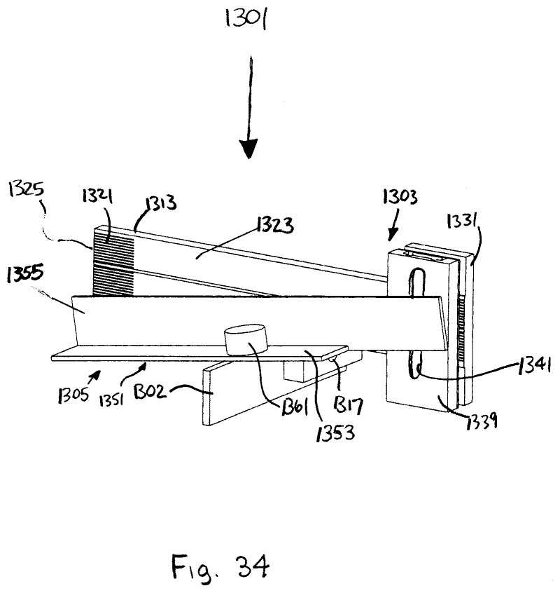

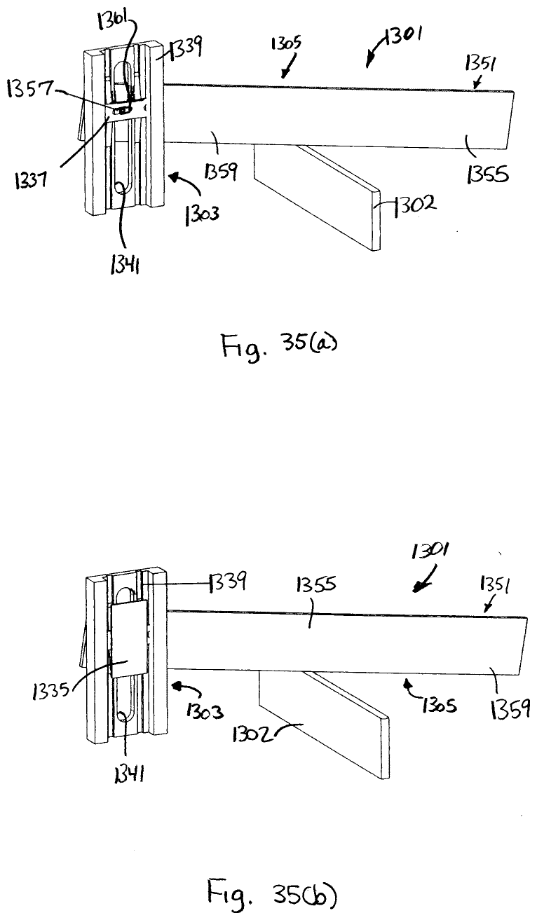

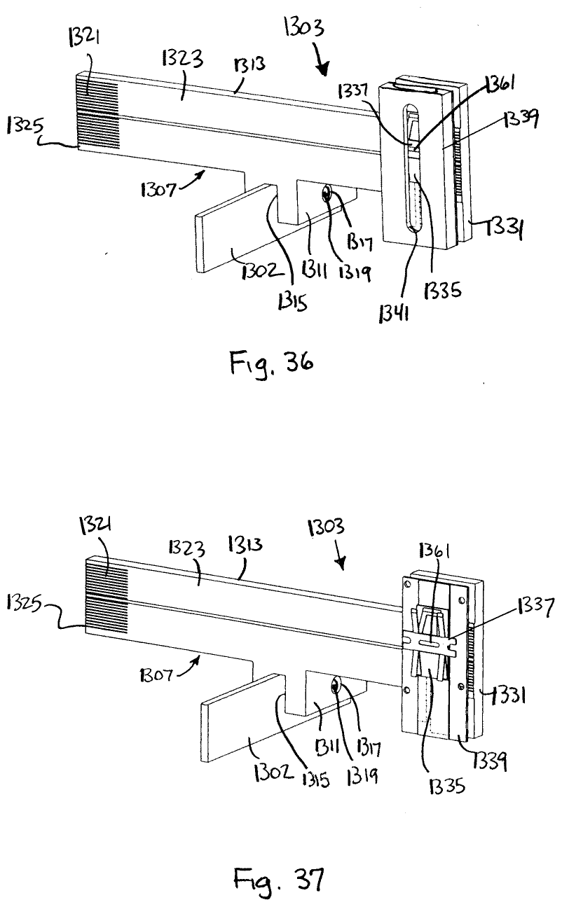

Referring now to FIGS. 34, 35(a) and 35(b), there are shown various views of a first alternate embodiment of a skate squareness checker to checker 8, the first alternate embodiment of a skate squareness checker being constructed according to the present disclosure and being represented generally by reference numeral 1301. Checker 1301 is shown in FIGS. 34, 35(a) and 35(b) mounted on an ice skate blade 1302.

Checker 1301 may comprise a squaring frame assembly 1303 and a measuring bracket assembly 1305. Squaring frame assembly 1303, which is also shown in FIGS. 36 and 37 with ice skate blade 1302, may comprise a squaring frame 1307. Squaring frame 1307 may be similar in many respects to squaring frame 1 of U.S. Pat. No. 5,345,688 and may comprise a frame body 1311 and an elongated member 1313. Frame body 1311 and elongated member 1313 may be formed as a unitary structure, as shown, or may be formed as separate pieces joined together. Frame body 1311 may be shaped to include a slot 1315 that may be appropriately dimensioned to receive ice skate blade 1302. Frame body 1311 may also include a through-hole 1317 that extends into slot 1315 and that may be used to receive a tightening screw 1319 for use in securing frame body 1311 to ice skate blade 1302. Elongated member 1313 may be positioned above frame body 1311 and may extend laterally in opposite directions for a short distance. Markings or other indicia 1321 may be provided on elongated member 1313, for example, on a first face 1323 of elongated member 1313 proximate to a first end 1325.

Squaring frame assembly 1303 may further comprise a reading unit 1331. Reading unit 1331, which may be identical to reading unit 1213 of checker 8, may be fixedly mounted on elongated member 1313, for example, by being fixedly mounted on first face 1323 of elongated member 1313 proximate to a second end thereof.

Squaring frame assembly 1303 may further comprise an electrode stator 1335. Electrode stator 1335, which may be identical to electrode stator 1211 of checker 8, may be fixedly mounted on a bracket 1337, which in turn, may be slidably mounted on a plate 1339. Plate 1339, in turn, may be fixedly coupled to reading unit 1331. For reasons to become apparent below, plate 1339 may be shaped to include a transverse slot 1341, which may be oriented to extend vertically.

Measuring bracket assembly 1305 may comprise a measuring bracket 1351. Measuring bracket 1351 may be similar in many respects to angle 3 of U.S. Pat. No. 5,345,688 and may comprise legs 1353 and 1355 forming a 90 degree angle. Measuring bracket 1351 may be a unitary structure, as shown, or may be made from two separate pieces joined together. A magnet 1361 may be mounted on leg 1353 of measuring bracket 1351 and may be used to at least temporarily secure leg 1353 of measuring bracket 1351 to ice skate blade 1302.

A pin 1357 (see FIG. 35(a)) may be mounted on a rear surface 1359 of leg 1355 and may extend rearwardly therefrom. Pin 1357 may be appropriately positioned and dimensioned to extend through slot 1341 in plate 1339 and may mate with a slot 1361 provided in bracket 1337. In this manner, depending on the evenness of ice skate blade 1302, as measuring bracket 1351 is positioned on top of ice skate blade 1302, electrode stator 1335 may be moved vertically upwardly or downwardly relative to reading unit 1331 by pin 1357.

Prior to using checker 1301 on an ice skate blade whose evenness is unknown, checker 1301 may be “zeroed” on a reference blade that is known to be even.

The squareness measurement obtained by checker 1301 in connection with an unknown blade may be displayed and utilized by checker 1301 in a fashion similar to that described above in connection with checker 8.

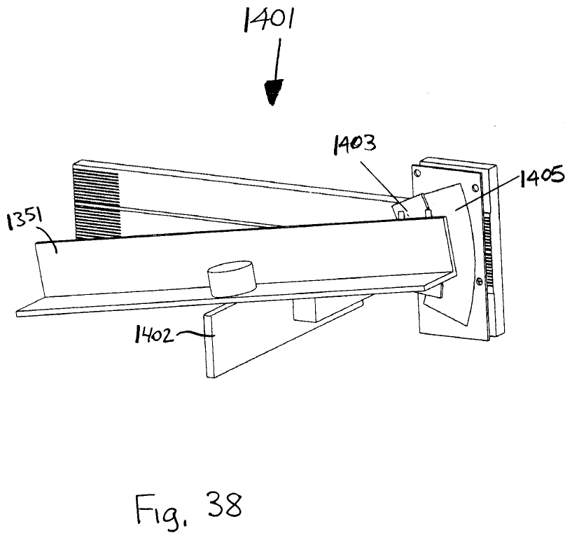

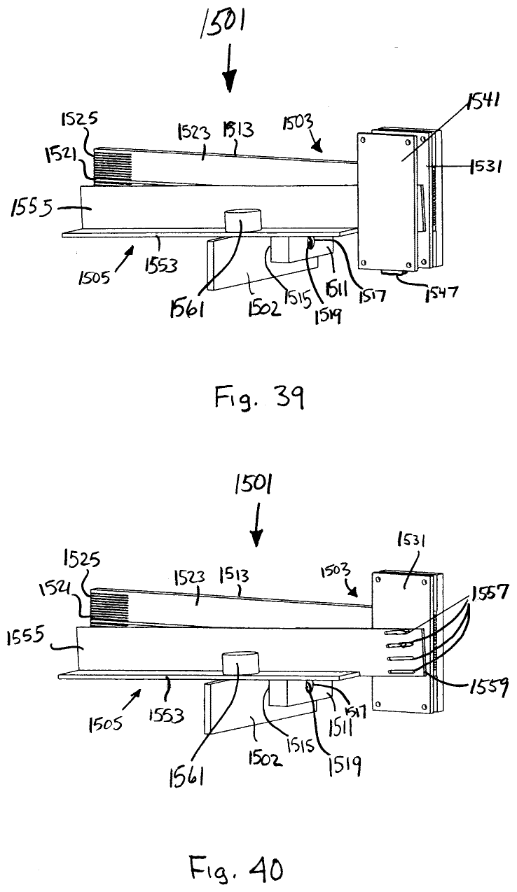

Referring now to FIG. 38, there is shown a perspective view of a second alternate embodiment of a skate squareness checker to skate squareness checker 8, the second alternate embodiment of a skate squareness checker being constructed according to the present disclosure and being represented generally by reference numeral 1401. Checker 1401 is shown mounted on an ice skate blade 1402.

Checker 1401 may be similar in most respects to checker 1301. One difference between the two checkers may be that, whereas checker 1301 may include an electrode stator 1335 and a reading unit 1331, checker 1401 may include an electrode stator 1403 and a reading unit 1405. Electrode stator 1403 may be an arc-shaped electrode stator that may be fixed to measuring bracket 1351. Reading unit 1405 may be a reading unit with an arc-shaper pickup circuit. As can be appreciated, as compared to checker 1301, checker 1401 effectively eliminates the arc-to-linear motion conversion.

Checker 1401 may be used in a fashion similar to that described above for checker 1301.

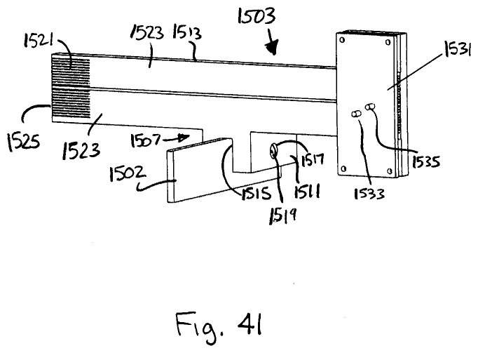

Referring now to FIGS. 39 and 40, there are shown various views of a third alternate embodiment of a skate squareness checker to skate squareness checker 8, the third alternate embodiment being constructed according to the present disclosure and being represented generally by reference numeral 1501. Device 1501 is shown in FIGS. 39 and 40 mounted on an ice skate blade 1502.

Checker 1501 may comprise a squaring frame assembly 1503 and a measuring bracket 1505. Squaring frame assembly 1503, which is also shown in FIG. 41 with ice skate blade 1502 but without its light detecting mechanism, may comprise a squaring frame 1507. Squaring frame 1507 may be similar to squaring frame 1307 of checker 1301 and may comprise a frame body 1511 and an elongated member 1513. Frame body 1511 and elongated member 1513 may be formed as a unitary structure, as shown, or may be formed as separate pieces joined together. Frame body 1511 may be shaped to include a slot 1515 that may be appropriately dimensioned to receive ice skate blade 1502. Frame body 1511 may also include a through-hole 1517 that extends into slot 1515 and that may be used to receive a tightening screw 1519 for use in securing frame body 1511 to ice skate blade 1502. Elongated member 1513 may be positioned above frame body 1511 and may extend laterally in opposite directions for a short distance. Markings or other indicia 1521 may be provided on elongated member 1513, for example, on a first face 1523 of elongated member 1513 proximate to a first end 1525.

Squaring frame assembly 1503 may further comprise a light emitting mechanism. In the present embodiment, such a light emitting mechanism may comprise a printed circuit board 1531 and a pair of light emitters 1533 and 1535. Printed circuit board 1531 may be fixedly mounted on elongated member 1513, for example, by being fixedly mounted on first face 1523 of elongated member 1513 proximate to a second end thereof. Light emitters 1533 and 1535, which may be, for example, focused light emitters, such as LEDs (e.g., standard or infrared) and/or lasers, may be coupled to printed circuit board 1531. Light emitters 1533 and 1535 may be oriented relative to printed circuit board 1531 so as to emit light in a direction perpendicularly away from printed circuit board 1531 and may be offset from one another, i.e., positioned at different heights relative to printed circuit board 1531.

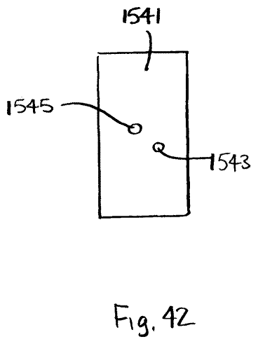

Squaring frame assembly 1503 may further comprise a light detecting mechanism. In the present embodiment, such a light detecting mechanism may comprise a printed circuit board 1541 and a pair of light detectors 1543 and 1545 (see FIG. 42). Printed circuit board 1541 may be fixedly coupled to printed circuit board 1531 by a plate 1547, and light detectors 1543 and 1545 may be coupled to printed circuit board 1541. Light detectors 1543 and 1545 may be arranged correspondingly to light emitters 1533 and 1535 so that light detector 1543 may detect light emitted from light emitter 1533 and so that light detector 1545 may detect light emitted from light emitter 1535.

Measuring bracket 1505 may be similar in some respects to measuring bracket 1351 of checker 1301 and may comprise legs 1553 and 1555 forming a 90 degree angle. Measuring bracket 1505 may differ notably from measuring bracket 1351 in that measuring bracket 1505 may be shaped to include a plurality of apertures 1557 located proximate to an end 1559 of leg 1555. Apertures 1557 may be positioned at different heights on leg 1555 and may be appropriately dimensioned and oriented so that the light from only one of light emitters 1533 and 1535 may be transmitted through any given aperture 1557 at one time.

A magnet 1561 may be mounted on leg 1553 of measuring bracket 1505 and may be used to at least temporarily secure leg 1553 of measuring bracket 1505 to ice skate blade 1502.

In use, checker 1501 may be used to determine the squareness of a blade by measuring the displacement of measuring bracket 1505 relative to squaring frame 1507. This may be done by detecting the light that is emitted from light emitters 1533 and 1535 by detectors 1543 and 1545 as measuring bracket 1505 passes therebetween. Light emitted from emitter 1533 or emitter 1535 that passes through an aligned aperture 1557 may be detected by its corresponding detector 1543 or 1545 whereas light that is not aligned with an aperture 1557 is not detected. In this manner, detected pulses of light passing through apertures 1557 may be counted as measuring bracket 1505 is displaced from the zero-offset position, with the number of counted pulses indicating the extent of displacement. A reason for using two emitter-detector pairs as shown in the present embodiment is to enable one to determine the direction of offset. By offsetting the two emitter-detector pairs from one another, when the apertures 1557 in measuring bracket 1505 pass by the two pairs, the first pair to see each other through the aperture indicates the direction of motion of measuring bracket 1505.

Prior to using checker 1501 on an ice skate blade whose evenness is unknown, checker 1501 may be “zeroed” on a reference blade that is known to be even.

The squareness measurement obtained by checker 1501 in connection with an unknown blade may be displayed and utilized by checker 1501 in a fashion similar to that described above in connection with checker 8.

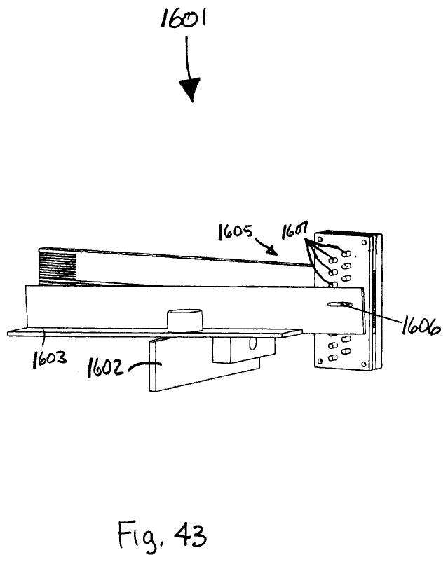

Referring now to FIG. 43, there is shown a front perspective view of a fourth alternate embodiment of a skate squareness checker to skate squareness checker 8, the fourth alternate embodiment being constructed according to the present disclosure and being represented generally by reference numeral 1601. Checker 1601 is shown in FIG. 43 mounted on an ice skate blade 1602.

Checker 1601 may be similar in most respects to checker 1501. One notable difference between the two checkers may be that, whereas checker 1501 may comprise a measuring bracket 1551 having a plurality of apertures 1557 and a squaring frame assembly 1503 that may comprise two light emitters 1533 and 1535 and two light detectors 1543 and 1545, checker 1601 may comprise a measuring bracket 1603 and a squaring frame assembly 1605. Measuring bracket 1605 may have a single aperture 1606. Squaring frame assembly 1605 may comprise several sets of light emitters 1607 and light detectors (not shown) that may be arranged so that, when measuring bracket 1605 is positioned at any of a number of different angular positions, one of the sets of light emitters 1607 and light detectors is aligned with aperture 1606. In this manner, the absolute location of measuring bracket 1605 may be known, thus eliminating the need, as is the case with checker 1501, to count pulses in order to determine the displacement of the measuring bracket relative to the squaring frame. Consequently, checker 1601 eliminates any error that may result from missing counts as the measuring bracket is displaced. Although checker 1601 requires a larger number of multiple emitter-detector pairs than is required by checker 1501, such emitters and detectors are relatively inexpensive electrical components.

An advantage of optically-based devices, such as checkers 1501 and 1601, as compared to devices utilizing capacitive sensors is that optics provides a measurement system that is stable in any sort of magnetic field, that is stable in humid environments, and that is much less sensitive to precise gaps between the components that are pivoting and those that are stable. For example, in devices utilizing a capacitive sensor, the stator needs to be held very close to the reading unit. This poses a challenge as the measuring bracket needs to rest on the contact edges of the skate blade and any friction between the measuring bracket and other objects may restrict its movement and affect the measurement.

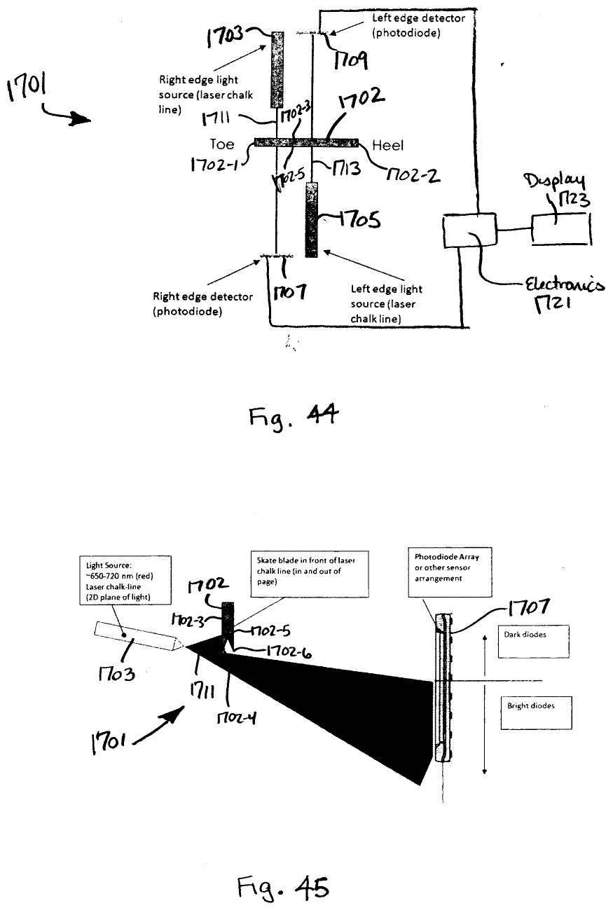

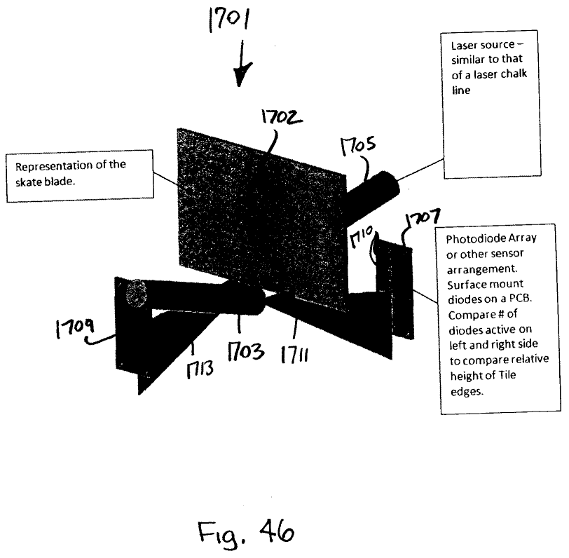

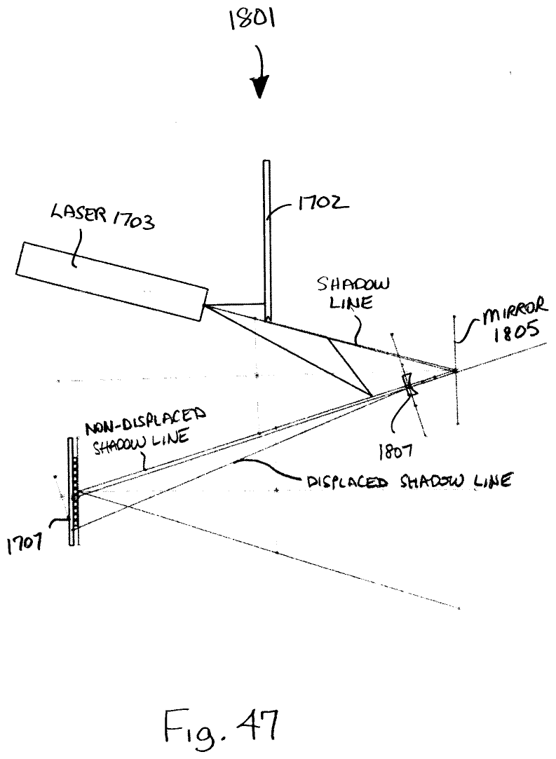

Referring now to FIGS. 44 through 46, there are shown various views of a fifth alternate embodiment of a skate squareness checker to skate squareness checker 8, the fifth alternate embodiment of a skate squareness checker being constructed according to the present disclosure and being represented generally by reference numeral 1701. Checker 1701 is shown in FIG. 44 through 46 in use with an ice skate blade 1702.

Checker 1701 may comprise a first light emitter 1703, a second light emitter 1705, a first light detector 1707, and a second light detector 1709. Each of light emitters 1703 and 1705 may be a light emitter of the type that generates a collimated light beam that extends in a direction perpendicular to its emission direction. Examples of such devices include, for example, laser chalk line devices, such as the BOSCH self-leveling cross-line laser (Robert Bosch Tool Corporation, Mount Prospect, IL). In the present embodiment, light emitter 1703 may be used to emit a chalk line 1711 that may run generally vertically, and light emitter 1705 may be used to emit a chalk line 1713 that may run generally vertically. Light emitters 1703 and 1705 may be positioned on opposite sides of skate blade 1702 and may be angled downwardly relative to the bottom edge of skate blade 1702, with each of light emitters 1703 and 1705 preferably being positioned at or near the same point along the longitudinal axis of ice skate blade 1702 between the toe end 1702-1 and the heel end 1702-2 thereof. More specifically, light emitter 1703 may be oriented relative to blade 1702 such that chalk line 1711 runs vertically along at least a portion of a side surface 1702-3 of blade 1702 and continues downwardly past the corresponding contact edge 1702-4 of blade 1702. In an analogous fashion, light emitter 705 may be oriented relative to blade 1702 such that chalk line 1713 runs vertically along at least a portion of a side surface 1702-5 of blade 1702 and continues downwardly past the corresponding contact edge 1702-6 of blade 1702.

Each of first light detector 1707 and second light detector 1709 may comprise a line or array of photodiodes 1710, with light detector 1707 being positioned on the opposite side of ice skate blade 1702 relative to first light emitter 1703 so as to detect light from light emitter 1703 and with light detector 1709 being positioned on the opposite side of ice skate blade 1702 relative to second light emitter 1705 so as to detect light from light emitter 1705.

In use, chalk line 1711 from light emitter 1703 is directed at side surface 1702-1 of ice skate blade 1702, and the portion of chalk line 1711 that is not blocked by side surface 1702-3 is detected by the thus illuminated photodiodes 1710 of light detector 1707. In an analogous fashion, chalk line 1713 from light emitter 1705 is directed at side surface 1702-5 of ice skate blade 1702, and the portion of chalk line 1711 that is not blocked by side surface 1702-5 is detected by the thus illuminated photodiodes 1710 of light detector 1709. As can be appreciated, because the lengths of contact edges 1702-4 and 1702-6 affect which photodiodes 1710 of light detectors 1707 and 1709 receive light from light emitters 1703 and 1705, respectively, one can determine the relative lengths of contact edges 1702-4 and 1702-6 by comparing the shadow edges (the line of delineation between the illuminated and non-illuminated photodiodes 1710) in light detectors 1707 and 1709, respectively. The respective signals from light detectors 1707 and 1709 may be analyzed using electronics 1721, and the result may be displayed using a display 1723.

Prior to using checker 1701 on an ice skate blade whose squareness is unknown, checker 1701 may be zeroed using a reference blade.

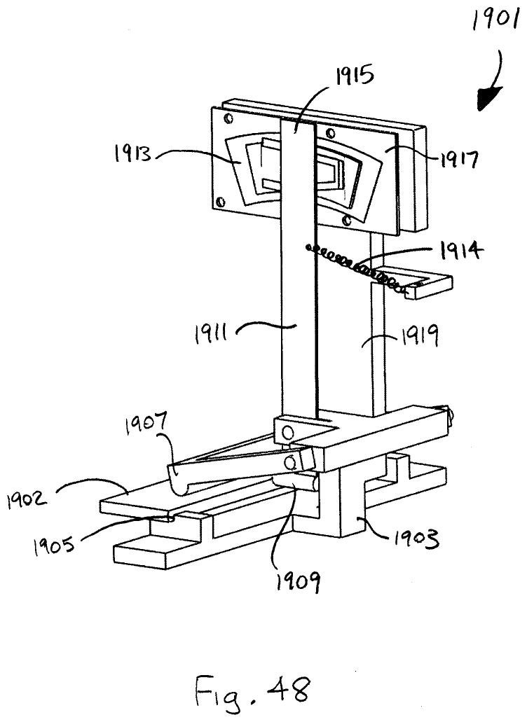

A variation on checker 1701 is shown in FIG. 47 by checker 1801. Checker 1801 utilizes optical components, such as a mirror 1805 and spreader optics 1807, to amplify the displacement of the shadow edge in order to have larger center-to-center distance requirements for the optical detector components. Without using the foregoing optical components, the amount the shadow edge displaces for a 0.001″ edge height change is relatively small compared to the size of the detector components. The subject optical components deflect the shadow line a greater distance than would be possible in a direct shadow approach.

Checkers 1701 and 1801 are unique in that these devices do not actually make physical contact with the ice skate blade. This may be advantageous as one may avoid errors of the type that could be introduced by devices in which a measuring bracket pivots on a squaring frame, such errors being caused, for example, by debris on the measuring bracket or misalignment of an electrode stator or reading unit. Checkers 1701 and 1801 also have the added benefit of showing a user exactly where the measurement is being taken as the laser chalk line is visible on the side surface of the ice skate blade. Another benefit to checkers 1701 and 1801 is that such devices are not prone to error due to shaking or gravity.

It should be understood that checkers 1701 and 1801 may be modified to eliminate second light emitter 1705 and second light detector 1709. In such an embodiment (not shown), there may be provided a contact member for contacting the first contact edge of the ice skate blade. Such a contact member may be spring-mounted. The second contact edge of the ice skate blade may be measured relative to the first contact edge of the ice skate blade in a fashion similar to the master/slave arrangement described above. The master edge used for calibration would again teach the system which of the photodiodes would be illuminated for a perfectly square blade. As a result, when an uneven blade is measured, the system would be able to quantify the difference.

Referring now to FIG. 48, there is shown a perspective view of a seventh alternate embodiment of a skate squareness checker to skate squareness checker 8, the seventh alternate embodiment being constructed according to the present disclosure and being represented generally by reference numeral 1901. Checker 1901 is shown in FIG. 48 with an ice skate blade 1902.

Checker 1901 may comprise a frame 1903. Frame 1903 may comprise a reference plane 1905 against which a skate blade 1902 may be clamped using a skate clamp 1907. A first contact edge of ice skate blade 1902 may be brought into contact with reference plane 1905, and a second contact edge of ice skate blade 1902 may be brought into contact with a first end 1909 of a pivotally-mounted arm 1911. Arm 1911 may be biased by an extension spring 1914. An arc-shaped electrode stator 1913 may be fixedly mounted on a second end 1915 of arm 1911, and a reading unit 1917 may be fixedly mounted on a vertical stand 1919 included in frame 1903.

Prior to using checker 1901 on an ice skate blade whose squareness is unknown, checker 1901 may be zeroed using a reference blade.

Checker 1901 utilizes a pivoting arm to amplify the mechanical displacement caused by the contact edge in contact therewith. Checker 1901 may use the capacitive or inductive sensor arrangement discussed above to provide a high resolution linear output. Checker 1901 also may use an arc-shaped stator and reading unit (but could just as easily use a normal stator and translate it with a pin-slot arrangement). This concept also eliminates the need for a magnet to track the edge of the blade which reduces the likelihood for metal particles to throw off the measurement. The concept also introduces a fixed pivot and an extension spring to both capture and bias the pivoting arm to follow the edge in contact therewith.

The mechanical amplification of checker 1901 may be used in connection with any of the other devices disclosed herein to increase the accuracy thereof. For example, the pivoting arm may provide a 5:1 amplification in a relatively small package using a 0.5″ blade edge to pivot point distance and a 2.5″ lever arm from the pivot point to the displacement measurement location. Some of the advantages of checker 1901 are that checker 1901 needs only a single hand to connect to a skate, does not use any magnets, obtains an edge height difference measurement automatically and can display the information to the user graphically, can be used to provide a clear recommendation on how to adjust a skate sharpening machine to bring the contact edges of a skate blade back to equal height, and obviates the need for trial and error iterations by the user.

The embodiments of the present disclosure described above are intended to be merely exemplary and those skilled in the art shall be able to make numerous variations and modifications to it without departing from the spirit of the present disclosure. All such variations and modifications are intended to be within the scope of the present disclosure as defined in the appended claims.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include these features, elements and/or states.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

Additionally, features described in connection with one embodiment can be incorporated into another of the disclosed embodiments, even if not expressly discussed herein, and embodiments having the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements and features referred to or indicated in the description of the application, individually or collectively, in any or all combinations of two or more of said parts, elements or features.

Where, in the foregoing description, reference has been made to integers or components having known equivalents thereof, those integers are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. The following lists have example embodiments that are within the scope of this disclosure. The example embodiments that are listed should in no way be interpreted as limiting the scope of the embodiments. Various features of the example embodiments that are listed can be removed, added, or combined to form additional embodiments, which are part of this disclosure:

### First Set of Example Embodiments

Various example embodiments of the disclosure can be described by the following clauses:

Clause 1. A skate sharpening system for sharpening an ice skate blade of an ice skate, the skate sharpening system comprising: (a) a skate sharpener, the skate sharpener being capable of being operated at a plurality of alternate settings; and (b) a skate checker, the skate checker being adapted to check the squareness of the ice skate blade and, based on the squareness of the ice skate blade, being adapted to provide a recommendation on a suitable setting for the skate sharpener.

Clause 2. The skate sharpening system as claimed in clause 1 wherein the skate checker is adapted to provide the recommendation in the form of an instruction to an operator as to how to adjust a setting on the skate sharpener.

Clause 3. The skate sharpening system as claimed in clause 1 further comprising automated means for adjusting a setting of the skate sharpener pursuant to the recommendation of the skate checker.

Clause 4. The skate sharpening system as claimed in clause 1 wherein the skate sharpener comprises a grinding stone and a dresser and wherein control of the dresser is automated.

Clause 5. The skate sharpening system as claimed in clause 1 wherein the skate sharpener comprises a housing, a grinding stone, and a vacuum, the grinding stone extending through an opening in the housing, the vacuum disposed in the housing and arranged to suction debris created by the sharpening of the ice skate blade by the grinding stone.

Clause 6. A skate sharpener for sharpening an ice skate blade of an ice skate, the skate sharpener comprising: (a) a housing, the housing having an opening; (b) a grinding stone adapted for shaping an ice skate blade, the grinding stone extending through the opening in the housing; (c) a motor operatively coupled to the grinding stone to cause the grinding stone to rotate; and (d) a vacuum disposed within the housing for suctioning debris created by the shaping of the ice skate blade by the grinding stone.

Clause 7. The skate sharpener as claimed in clause 6 wherein the housing comprises a removable drawer in which debris suctioned by the vacuum is collected.

Clause 8. The skate sharpener as claimed in clause 6 further comprising a dresser for reshaping the grinding stone.

Clause 9. The skate sharpener as claimed in clause 8 wherein the dresser is disposed within the housing.

Clause 10. The skate sharpener as claimed in clause 8 further comprising a mechanism for moving the dresser into contact with the grinding stone.

Clause 11. The skate sharpener as claimed in clause 10 wherein said dresser moving mechanism is at least partially automated.

Clause 12. The skate sharpener as claimed in clause 6 further comprising a skate mount for holding the ice skate.

Clause 13. The skate sharpener as claimed in clause 12 further comprising a mechanism for moving at least one of the ice skate and the grinding stone relative to the other so that the ice skate blade is passed against the grinding stone.

Clause 14. The skate sharpener as claimed in clause 13 wherein said moving mechanism is at least partially automated.

Clause 15. The skate sharpener as claimed in clause 14 wherein at least one of the grinding stone and the skate mount is adjustably mounted so that the positioning of the grinding stone relative to the bottom of the ice skate blade may be altered.

Clause 16. A skate sharpener for sharpening an ice skate blade of an ice skate, the skate sharpener comprising: (a) a grinding stone adapted for shaping an ice skate blade; (b) a motor operatively coupled to the grinding stone to cause the grinding stone to rotate; and (c) a dresser adapted to dress the grinding stone, wherein control of the dresser is automated.

Clause 17. The skate sharpener as claimed in clause 16 further comprising a housing, wherein each of the grinding stone, the motor and the dresser is disposed within the housing.

Clause 18. The skate sharpener as claimed in clause 17 wherein the housing comprises a removable drawer in which debris is collected.

Clause 19. The skate sharpener as claimed in clause 16 further comprising a skate mount for holding the ice skate.

Clause 20. The skate sharpener as claimed in clause 19 further comprising a mechanism for moving at least one of the ice skate and the grinding stone relative to the other so that the ice skate blade is passed against the grinding stone.

Clause 21. The skate sharpener as claimed in clause 20 wherein said moving mechanism is at least partially automated.

Clause 22. The skate sharpener as claimed in clause 20 wherein at least one of the grinding stone and the skate mount is adjustably mounted so that the positioning of the grinding stone relative to the bottom of the ice skate blade may be altered.

Clause 23. A skate sharpener for sharpening an ice skate blade of an ice skate, the skate sharpener comprising: (a) a grinding stone adapted for shaping an ice skate blade; (b) a motor operatively coupled to the grinding stone to cause the grinding stone to rotate; (c) a skate mount for holding an ice skate; and (d) a spring-loaded pivot mechanism for maintaining constant force of the grinding stone against the ice skate in the skate mount.

Clause 24. The skate sharpener as claimed in clause 23 further comprising a housing and a vacuum, the grinding stone extending through an opening in the housing, the vacuum being disposed within the housing for suctioning debris created by the shaping of the ice skate blade by the grinding stone.

Clause 25. The skate sharpener as claimed in clause 23 wherein the housing comprises a removable drawer in which debris suctioned by the vacuum is collected.

Clause 26. The skate sharpener as claimed in clause 23 further comprising a dresser for reshaping the grinding stone.

Clause 27. The skate sharpener as claimed in clause 26 wherein the dresser is disposed within the housing.

Clause 28. The skate sharpener as claimed in clause 26 further comprising a mechanism for moving the dresser into contact with the grinding stone.

Clause 29. The skate sharpener as claimed in clause 28 wherein said dresser moving mechanism is at least partially automated.

Clause 30. The skate sharpener as claimed in clause 23 further comprising a mechanism for moving at least one of the ice skate and the grinding stone relative to the other so that the ice skate blade is passed against the grinding stone.

Clause 31. The skate sharpener as claimed in clause 30 wherein said moving mechanism is at least partially automated.

Clause 32. The skate sharpener as claimed in clause 23 wherein at least one of the grinding stone and the skate mount is adjustably mounted so that the positioning of the grinding stone relative to the bottom of the ice skate blade may be altered.

Clause 33. A skate sharpener for sharpening an ice skate blade of an ice skate, the skate sharpener comprising: (a) a grinding stone adapted for shaping an ice skate blade; (b) a motor operatively coupled to the grinding stone to cause the grinding stone to rotate; (c) a skate mount adapted to hold an ice skate; and (d) a mechanism for moving the skate mount relative to the grinding stone, the mechanism comprising a rail, the skate mount slidably mounted on the rail, and motorized means for driving the skate mount along the rail.

Clause 34. A skate sharpener for sharpening an ice skate blade of an ice skate, the skate sharpener comprising: (a) a grinding stone adapted for shaping an ice skate blade; (b) a motor operatively coupled to the grinding stone to cause the grinding stone to rotate; (c) a skate mount for holding an ice skate; and (d) a counterweight coupled to the grinding stone for maintaining constant force of the grinding stone against the ice skate in the skate mount.

### Second Set of Example Embodiments

Various example embodiments of the disclosure can be described by the following clauses:

Clause 1. A device for determining the squareness of an ice skate blade, the ice skate blade having a first contact edge and a second contact edge, the device comprising: (a) a support; (b) a first contact member, the first contact member being adapted to be displaced relative to the support when the first contact member is brought into contact with the first contact edge of the ice skate blade, the first contact member being biased towards making contact with the first contact edge of the ice skate blade; (c) a second contact member, the second contact member being capable of being displaced relative to the first contact member when the second contact member is brought into contact with the second contact edge of the ice skate blade, the second contact member being biased towards making contact with the second contact edge of the ice skate blade; and (d) automated means for determining the displacement of the second contact member relative to the first contact member.

Clause 2. The device as claimed in clause 1 wherein said automated means comprises a capacitive measurement circuit, an inductive measurement circuit or any other linear measurement sensor arrangement.

Clause 3. The device as claimed in clause 2 wherein said capacitive measurement circuit comprises an electrode stator and a reading unit, the electrode stator being mechanically coupled to one of the first contact member and the second contact member, the reading unit being mechanically coupled to the other of the first contact member and the second contact member.

Clause 4. The device as claimed in clause 3 wherein said electrode stator is mechanically coupled to the second contact member and the reading unit is mechanically coupled to the first contact member.

Clause 5. The device as claimed in clause 4 further comprising a post and a carriage, wherein the post is mounted on the support, the carriage is slidably mounted on the post, and the reading unit and the first contact member are mechanically coupled to the carriage.

Clause 6. The device as claimed in clause 5 further comprising a plunger, wherein the plunger is slidably mounted on the carriage, and the electrode stator and the second contact member are mechanically coupled to the plunger.

Clause 7. The device as claimed in clause 1 further comprising a display for displaying the squareness determined by the automated means and/or for instructing a user to make an adjustment to a skate sharpening machine.

Clause 8. The device as claimed in clause 7 wherein said display is configured to display the squareness with a numerical representation.

Clause 9. The device as claimed in clause 7 wherein said display is configured to display the squareness with a graphic representation.

Clause 10. A device for determining the squareness of an ice skate blade, the ice skate blade having a first surface, a second surface, and a connecting surface, the first surface and the connecting surface meeting at a first contact edge, the second surface and the connecting surface meeting at a second contact edge, the device comprising: (a) a squaring frame, the squaring frame comprising a frame body and an elongated member, the frame body being adapted to be mounted along one of the first surface and the second surface of the ice skate blade, with the elongated member extending perpendicularly to the frame body; (b) a measuring bracket, the measuring bracket being adapted to be seated across the first and second contact edges of the ice skate blade; and (c) automated means for determining the angular displacement of the measuring bracket relative to the elongated member of the squaring frame.

Clause 11. The device as claimed in clause 10 wherein said automated means comprises a capacitive measurement circuit, an inductive measurement circuit or any other linear measurement sensor arrangement.

Clause 12. The device as claimed in clause 11 wherein said capacitive measurement circuit comprises an electrode stator and a reading unit.

Clause 13. The device as claimed in clause 12 wherein one of said reading unit and said electrode stator is fixed relative to said elongated member of the squaring frame and wherein the other of said reading unit and said electrode stator is mechanically coupled to the measuring bracket.

Clause 14. The device as claimed in clause 13 wherein the electrode stator is an arc-shaped electrode stator fixed to the measuring bracket.

Clause 15. The device as claimed in clause 13 further comprising a plate mechanically coupled to the reading unit, a stator bracket fixed to the electrode stator, and a pin fixed to the measuring bracket, wherein the electrode stator is slidably mounted on the plate and wherein the pin is mechanically coupled to the stator bracket.

Clause 16. The device as claimed in clause 11 wherein said automated means comprises photonics.

Clause 17. The device as claimed in clause 16 wherein said automated means comprises at least one light emitter/light detector pair coupled to the squaring frame, the measuring bracket being positioned between the light emitter/light detector pair and comprising an aperture through which the light from the light emitter can pass to the light detector.

Clause 18. The device as claimed in clause 17 wherein said at least one light emitter/light detector pair comprises exactly two light emitter/light detector pairs, the exactly two light emitter/light detector pairs being positioned at different heights.

Clause 19. The device as claimed in clause 18 wherein said measuring bracket comprises a plurality of apertures through any of which the light from only one light emitter can pass at a time.

Clause 20. The device as claimed in clause 17 wherein said at least one light emitter/light detector pair comprises more than two light emitters and more than two light detectors and wherein said measuring bracket comprises a single aperture through which the light from only one light emitter can pass at a time.

Clause 21. The device as claimed in clause 10 further comprising a display for displaying the squareness determined by the automated means and/or for instructing a user to make an adjustment to a skate sharpening machine.

Clause 22. The device as claimed in clause 21 wherein said display is configured to display the squareness with a numerical representation.

Clause 23. The device as claimed in clause 21 wherein said display is configured to display the squareness with a graphic representation.

Clause 24. A device for determining the squareness of an ice skate blade, the ice skate blade having a first contact edge and a second contact edge, the device comprising: (a) a first contact member, the first contact member being adapted to contact the first contact edge of the ice skate blade; (b) a second contact member, the second contact member being capable of being displaced relative to the first contact member when the second contact member is brought into contact with the second contact edge of the ice skate blade, the second contact member being biased towards making contact with the second contact edge of the ice skate blade; and (c) automated means for determining the displacement of the second contact member relative to the first contact member.

Clause 25. The device as claimed in clause 24 wherein the first contact member is movable.

Clause 26. The device as claimed in clause 25 wherein the first contact member is coupled to a pivotable arm.

Clause 27. The device as claimed in clause 24 wherein the second contact member comprises a pivotable arm.

Clause 28. The device as claimed in clause 24 wherein said automated means comprises a capacitive measurement circuit, an inductive measurement circuit or any other linear measurement sensor arrangement.

Clause 29. The device as claimed in clause 24 further comprising a display for displaying the squareness determined by the automated means and/or for instructing a user to make an adjustment to a skate sharpening machine.

Clause 30. The device as claimed in clause 24 wherein said automated determining means makes a measurement only after the first contact member is confirmed to be in contact with the first contact edge of the skate.

Clause 31. A device for determining the squareness of an ice skate blade, the ice skate blade having a first surface, a second surface, and a connecting surface, the first surface and the connecting surface meeting at a first contact edge, the second surface and the connecting surface meeting at a second contact edge, the device comprising: (a) a first light source, the first light source generating a first line of light; (b) a second light source, the second light source generating a second line of light; (c) a first light detector, the first light detector comprising a first array of photodiodes; (d) a second light detector, the second light detector comprising a second array of photodiodes; (e) wherein the first light source and the first light detector are positioned on opposite sides of the ice skate blade, wherein the first light detector is positioned such that a portion of the photodiodes of the first array is illuminable with the first line of light and a portion of the photodiodes of the first array is not illuminable with the first line of light due to the presence of the first contact edge; (f) wherein the second light source and the second light detector are positioned on opposite sides of the ice skate blade, wherein the first light source and the second light source are positioned on opposite sides of the ice skate blade, and wherein the second light detector is positioned such that a portion of the photodiodes of the second array is illuminable with the second line of light and a portion of the photodiodes of the second array is not illuminable with the second line of light due to the presence of the second contact edge; and (g) automated means for determining the squareness of the ice skate blade based on the relative portions of illuminated photodiodes in the first and second light detectors.

Clause 32. The device as claimed in clause 31 further comprising a display for displaying the squareness determined by the automated means and/or for instructing a user to make an adjustment to a skate sharpening machine.

Clause 33. The device as claimed in clause 31 wherein said display is configured to display the squareness with a numerical representation.

Clause 34. The device as claimed in clause 31 wherein said display is configured to display the squareness with a graphic representation.

Clause 35. A device for determining the squareness of an ice skate blade, the ice skate blade having a first surface, a second surface, and a connecting surface, the first surface and the connecting surface meeting at a first contact edge, the second surface and the connecting surface meeting at a second contact edge, the device comprising: (a) a support; (b) a first contact member, the first contact member being adapted to be displaced relative to the support when the first contact member is brought into contact with the first contact edge of the ice skate blade, the first contact member being biased towards making contact with the first contact edge of the ice skate blade; (c) a first light source, the first light source generating a first line of light; (d) a first light detector, the first light detector comprising a first array of photodiodes; (e) wherein the first light source and the first light detector are positioned on opposite sides of the ice skate blade, wherein the first light detector is positioned such that a portion of the photodiodes of the first array is illuminable with the first line of light and a portion of the photodiodes of the first array is not illuminable with the first line of light due to the presence of the second contact edge; and (f) automated means for determining the squareness of the ice skate blade by measuring the height of the second contact edge relative to the first contact edge using the relative portions of illuminated and nonilluminated photodiodes in the first light detector.

Clause 36. The device as claimed in clause 35 further comprising a display for displaying the squareness determined by the automated means and/or for instructing a user to make an adjustment to a skate sharpening machine.

Clause 37. The device as claimed in clause 35 wherein said display is configured to display the squareness with a numerical representation.

Clause 38. The device as claimed in clause 35 wherein said display is configured to display the squareness with a graphic representation.

Clause 39. A method for determining the squareness of an ice skate blade, the ice skate blade having a first contact edge and a second contact edge, the method comprising: (a) providing a first contact member, the first contact member being adapted to contact the first contact edge of the ice skate blade; (b) providing a second contact member, the second contact member being capable of being displaced relative to the first contact member when the second contact member is brought into contact with the second contact edge of the ice skate blade, the second contact member being biased towards making contact with the second contact edge of the ice skate blade; (c) bringing the first contact edge of the ice skate blade into contact with the first contact member; (d) bringing the second contact edge of the ice skate blade into contact with the second contact member; (e) using automated means to determine the displacement of the second contact member relative to the first contact member.

Clause 40. The method as claimed in clause 39 further comprising the steps of displaying the squareness of the ice skate blade based on the displacement of the second contact member relative to the first contact member and/or instructing a user to make an adjustment to a skate sharpening machine based on the squareness of the ice skate blade.

Clause 41. A method of sharpening an ice skate blade, said method comprising the steps of: (a) using a skate sharpening machine to sharpen the ice skate blade; (b) then, determining the squareness of the ice skate blade with a squareness determining device, the squareness determining device comprising automated means for recommending any needed setting adjustments to be made to the skate sharpening machine; (c) then, if needed, adjusting one or more settings to the skate sharpening machine pursuant to the recommendations of the squareness determining device and then repeating steps (a) and (b) one or more times until the ice skate blade is sharpened to a desired squareness.

What is claimed is:

1. A device for determining squareness of an ice skate blade, the ice skate blade having a first contact edge and a second contact edge, the device comprising:
(a) a support;
(b) a first contact member, the first contact member being adapted to be displaced relative to the support when the first contact member is brought into contact with the first contact edge of the ice skate blade, the first contact member being biased towards making contact with the first contact edge of the ice skate blade;
(c) a second contact member, the second contact member being capable of being displaced relative to the first contact member when the second contact member is brought into contact with the second contact edge of the ice skate blade, the second contact member being biased towards making contact with the second contact edge of the ice skate blade; and
(d) automated means for determining the displacement of the second contact member relative to the first contact member.

2. The device as claimed in claim 1, wherein said automated means comprises a capacitive measurement circuit, an inductive measurement circuit or any other linear measurement sensor arrangement.

3. The device as claimed in claim 2, wherein said capacitive measurement circuit comprises an electrode stator and a reading unit, the electrode stator being mechanically coupled to one of the first contact member and the second contact member, the reading unit being mechanically coupled to the other of the first contact member and the second contact member.

4. The device as claimed in claim 3, wherein said electrode stator is mechanically coupled to the second contact member and the reading unit is mechanically coupled to the first contact member.

5. The device as claimed in claim 4, further comprising a post and a carriage, wherein the post is mounted on the support, the carriage is slidably mounted on the post, and the reading unit and the first contact member are mechanically coupled to the carriage.

6. The device as claimed in claim 5, further comprising a plunger, wherein the plunger is slidably mounted on the carriage, and the electrode stator and the second contact member are mechanically coupled to the plunger.

7. The device as claimed in claim 1, further comprising a display for displaying the squareness determined by the automated means and/or for instructing a user to make an adjustment to a skate sharpening machine.

8. The device as claimed in claim 7, wherein said display is configured to display the squareness with a numerical representation.

9. The device as claimed in claim 7, wherein said display is configured to display the squareness with a graphic representation.

10. A device for determining squareness of an ice skate blade, the ice skate blade having a first surface, a second surface, and a connecting surface, the first surface and the connecting surface meeting at a first contact edge, the second surface and the connecting surface meeting at a second contact edge, the device comprising:
(a) a squaring frame, the squaring frame comprising a frame body and an elongated member, the frame body being adapted to be mounted along one of the first surface and the second surface of the ice skate blade, with the elongated member extending perpendicularly to the frame body;
(b) a measuring bracket, the measuring bracket being adapted to be seated across the first and second contact edges of the ice skate blade; and
(c) automated means for determining angular displacement of the measuring bracket relative to the elongated member of the squaring frame.

11. The device as claimed in claim 10, wherein said automated means comprises a capacitive measurement circuit, an inductive measurement circuit or any other linear measurement sensor arrangement.

12. The device as claimed in claim 11, wherein said capacitive measurement circuit comprises an electrode stator and a reading unit.

13. The device as claimed in claim 12, wherein one of said reading unit and said electrode stator is fixed relative to said elongated member of the squaring frame and wherein the other of said reading unit and said electrode stator is mechanically coupled to the measuring bracket.

14. The device as claimed in claim 13, wherein the electrode stator is an arc-shaped electrode stator fixed to the measuring bracket.

15. The device as claimed in claim 13, further comprising a plate mechanically coupled to the reading unit, a stator bracket fixed to the electrode stator, and a pin fixed to the measuring bracket, wherein the electrode stator is slidably mounted on the plate and wherein the pin is mechanically coupled to the stator bracket.

16. The device as claimed in claim 11, wherein said automated means comprises photonics.

17. The device as claimed in claim 16, wherein said automated means comprises at least one light emitter and light detector pair coupled to the squaring frame, the measuring bracket being positioned between the light emitter and light detector pair and comprising an aperture through which the light from the light emitter can pass to the light detector.

18. The device as claimed in claim 17, wherein said at least one light emitter/light detector pair comprises exactly two light emitter/light detector pairs, the exactly two light emitter/light detector pairs being positioned at different heights.

19. The device as claimed in claim 18, wherein said measuring bracket comprises a plurality of apertures through any of which the light from only one light emitter can pass at a time.

20. The device as claimed in claim 17, wherein said at least one light emitter/light detector pair comprises more than two light emitters and more than two light detectors and wherein said measuring bracket comprises a single aperture through which the light from only one light emitter can pass at a time.
